(19) United States
(12) Patent Application Publication
(10) Pub. No.: US 2025/0213955 A1
(43) Pub. Date: Jul. 3, 2025

(54) HEALTHY ACTIVITY AND FAN ENGAGEMENT SYSTEM

(71) Applicant: ACTVFAN, Inc., San Diego, CA (US)

(72) Inventors: Rogério Carlson, San Diego, CA (US); Tawnia Gillespie, San Diego, CA (US)

(21) Appl. No.: 19/003,590

(22) Filed: Dec. 27, 2024

Related U.S. Application Data
(60) Provisional application No. 63/615,741, filed on Dec. 28, 2023.

(51) Int. Cl. A63B 71/06; G06Q 10/0639

(52) U.S. Cl. CPC A63B 71/0616; G06Q 10/0639

(57) ABSTRACT

A physical activity and fan engagement system includes a server application and a user application. The server associates a first plurality of users with a first organization and a second plurality of users with a second organization. The user applications track physical activity the first plurality of users and the second plurality of users. The server aggregates the tracked physical activity of the first plurality of users to determine a first organization amount of physical activity. The server also aggregates the tracked physical activity of the second plurality of users to determine a second organization amount of physical activity. The server then compares the first organization amount of physical activity to the second organization amount of physical activity to determine a winner in a competition between the first plurality of users associated with the first organization and the second plurality of users associated with the second organization.

### RELATED APPLICATION

The present application claims priority to U.S. provisional patent application No. 63/615,741 filed Dec. 28, 2023, which is incorporated herein by reference in its entirety.

### BACKGROUND

### Field of the Invention

The present disclosure is generally related to healthy activity engagement and more particularly related to engagement of fans of teams, schools, and leagues to promote healthy activity.

### Related Art

Nearly 80% of the U.S. population is physically inactive or does not meet the minimum recommended levels of daily activity. Organizations, such as professional sport franchises, leagues (sports or otherwise), schools, teams, and the like are chronically challenged with engaging with fans and/or members on a year-round basis, for example, in the off-season, when school is out of session, during non-game days, etc. Additionally, some of these types of organizations experience particular difficulty connecting and engaging with younger people.

### SUMMARY

The present disclosure provides a physical activity and fan engagement application (“app”) for teams, schools, and leagues that promotes community health through physical activity tracking, gamification, and technology.

In some aspects, the techniques described herein relate to a system including at least one processor communicatively coupled with at least one non-transitory computer readable medium, wherein the processor is programmed to: associate a first plurality of users with a first organization; associate a second plurality of users with a second organization; track physical activity of one or more of the first plurality of users; aggregate the tracked physical activity of the one or more of the first plurality of users to determine a first organization amount of physical activity; track physical activity of one or more of the second plurality of users; aggregate the tracked physical activity of the one or more of the second plurality of users to determine a second organization amount of physical activity; compare the first organization amount of physical activity to the second organization amount of physical activity to determine a winner in a competition between the first plurality of users associated with the first organization and the second plurality of users associated with the second organization.

In some aspects, the techniques described herein relate to a computer implemented method where one or more processors are programmed to perform steps including: associate a first plurality of users with a first organization; associate a second plurality of users with a second organization; track physical activity of one or more of the first plurality of users; aggregate the tracked physical activity of the one or more of the first plurality of users to determine a first organization amount of physical activity; track physical activity of one or more of the second plurality of users; aggregate the tracked physical activity of the one or more of the second plurality of users to determine a second organization amount of physical activity; compare the first organization amount of physical activity to the second organization amount of physical activity to determine a winner in a competition between the first plurality of users associated with the first organization and the second plurality of users associated with the second organization.

In some aspects, the techniques described herein relate to a non-transitory computer readable medium having stored thereon one or more sequences of instructions for causing one or more processors to perform steps including: associate a first plurality of users with a first organization; associate a second plurality of users with a second organization; track physical activity of one or more of the first plurality of users; aggregate the tracked physical activity of the one or more of the first plurality of users to determine a first organization amount of physical activity; track physical activity of one or more of the second plurality of users; aggregate the tracked physical activity of the one or more of the second plurality of users to determine a second organization amount of physical activity; compare the first organization amount of physical activity to the second organization amount of physical activity to determine a winner in a competition between the first plurality of users associated with the first organization and the second plurality of users associated with the second organization.

Other features and advantages of the present invention will become more readily apparent to those of ordinary skill in the art after reviewing the following detailed description and accompanying drawings.

### BRIEF DESCRIPTION OF THE DRAWINGS

The structure and operation of the present invention will be understood from a review of the following detailed description and the accompanying drawings in which like reference numerals refer to like parts and in which:

FIG. 1 illustrates an example infrastructure, in which one or more of the processes described herein may be implemented, according to an embodiment;

FIG. 2 illustrates an example processing system, by which one or more of the processes described herein may be executed, according to an embodiment;

FIGS. 3-9 illustrate example flow diagrams of example user interface screens, according to an embodiment; and

FIGS. 10-70 illustrate detailed views of example user interface screens, according to an embodiment.

### DETAILED DESCRIPTION

Disclosed herein are systems, methods, and non-transitory computer-readable media for engaging individuals associated with an organization through physical activity. In one aspect, the system is deployed as an application (“app”) that executes on a user's mobile device. The app allows users to compete with other users on behalf of their selected organization, for example, a professional sports team. A method disclosed herein allows the app to reward users, on behalf of the organization, for exercising and moving.

After reading this description it will become apparent to one skilled in the art how to implement the invention in various alternative embodiments and alternative applications. However, although various embodiments of the present invention will be described herein, it is understood that these embodiments are presented by way of example only, and not limitation. As such, this detailed description of various alternative embodiments should not be construed to limit the scope or breadth of the present invention as set forth in the appended claims.

### Introduction

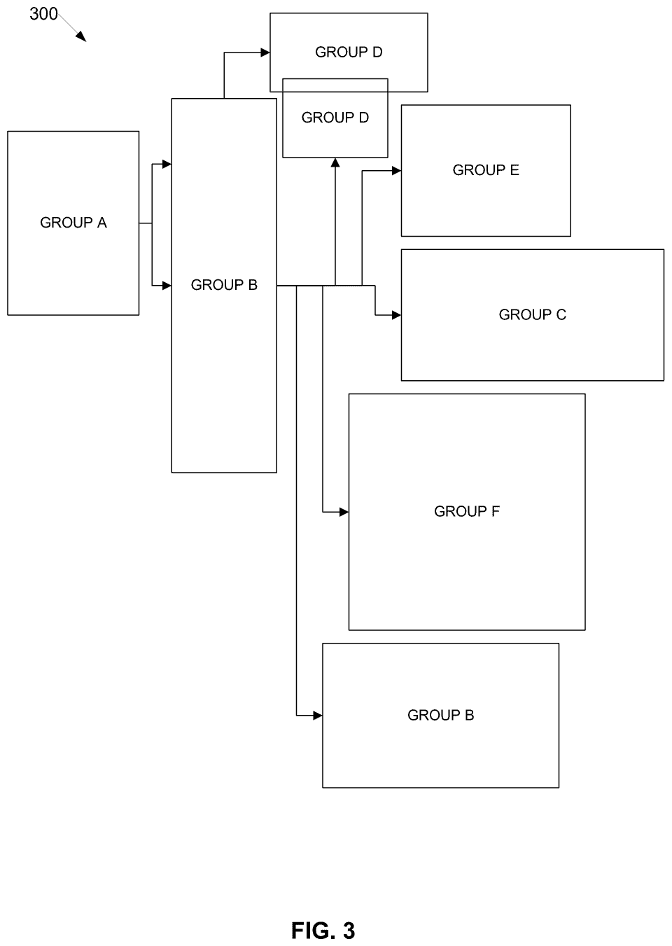

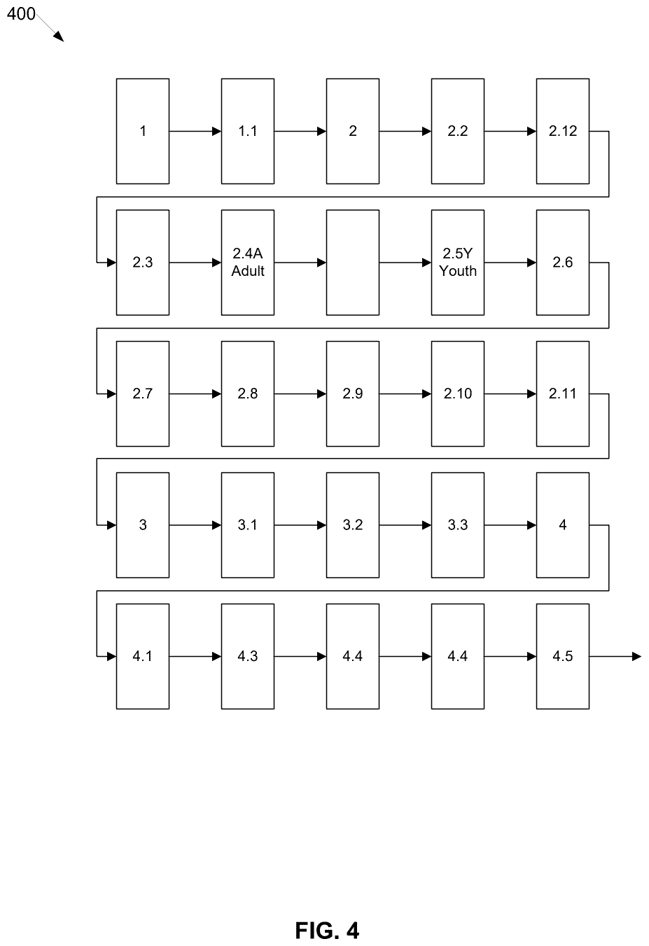

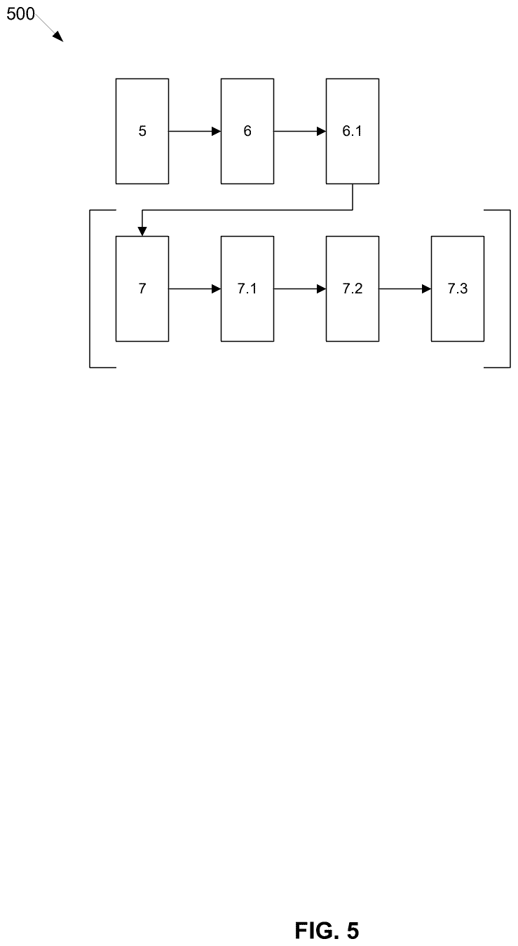

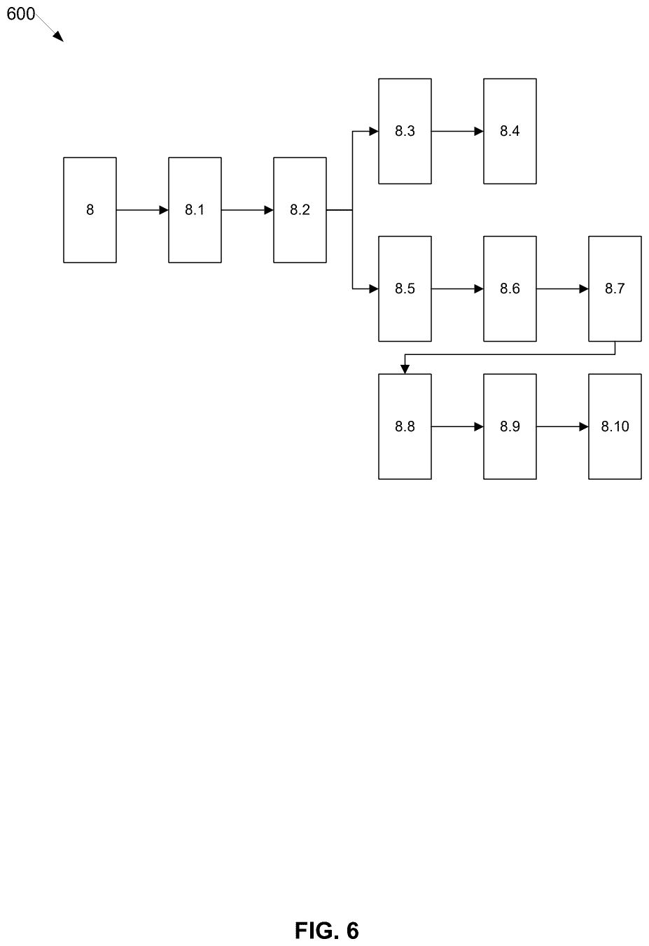

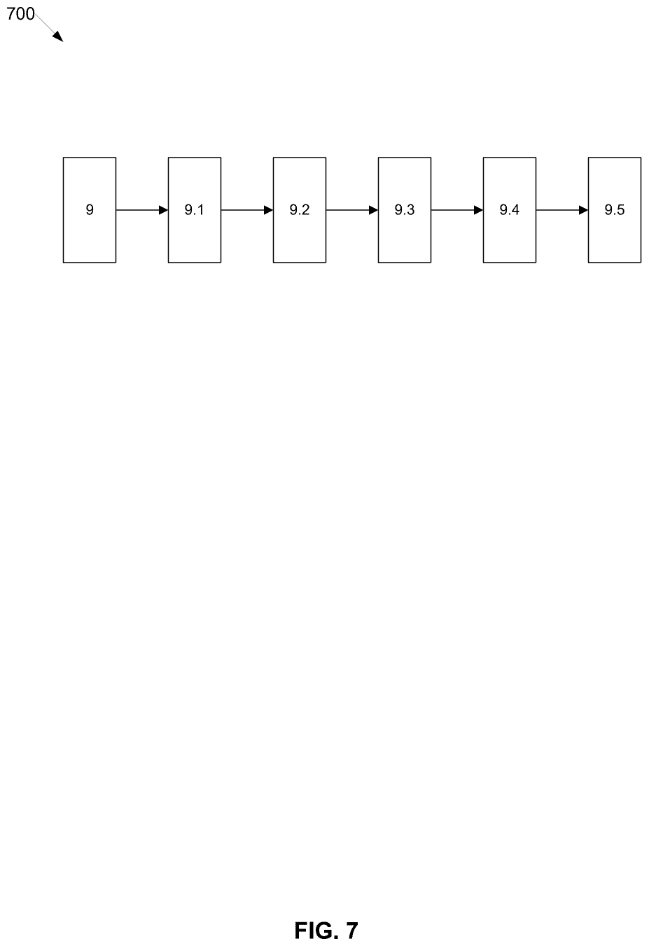

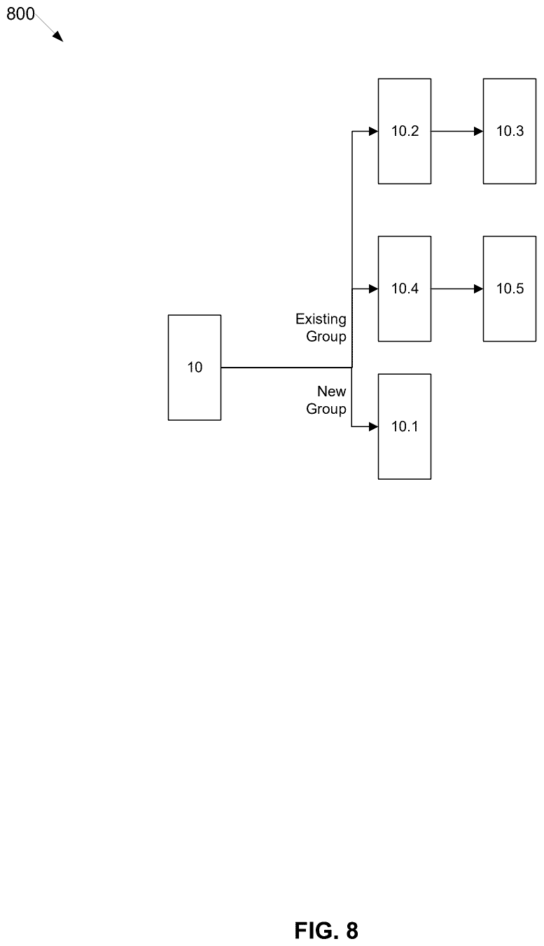

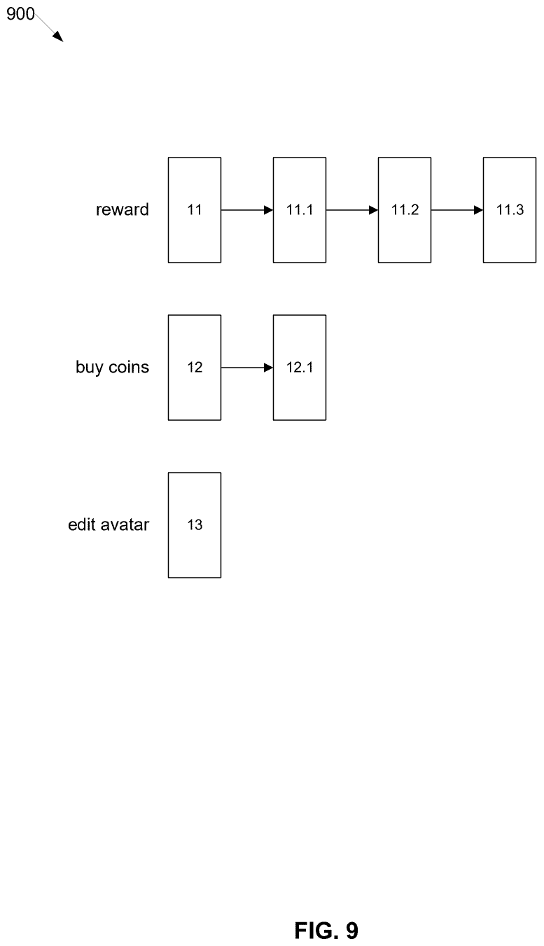

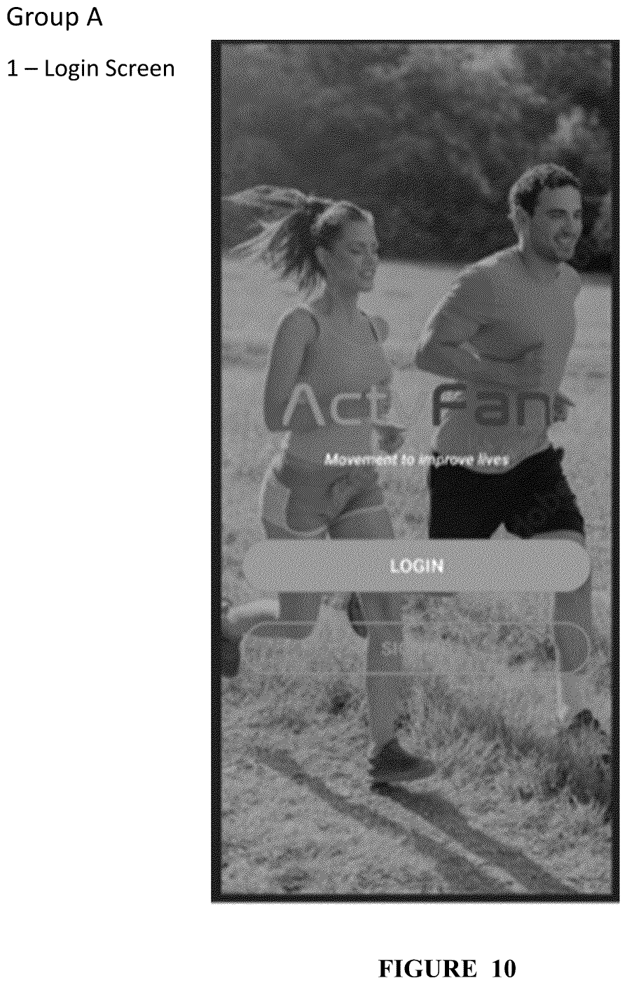

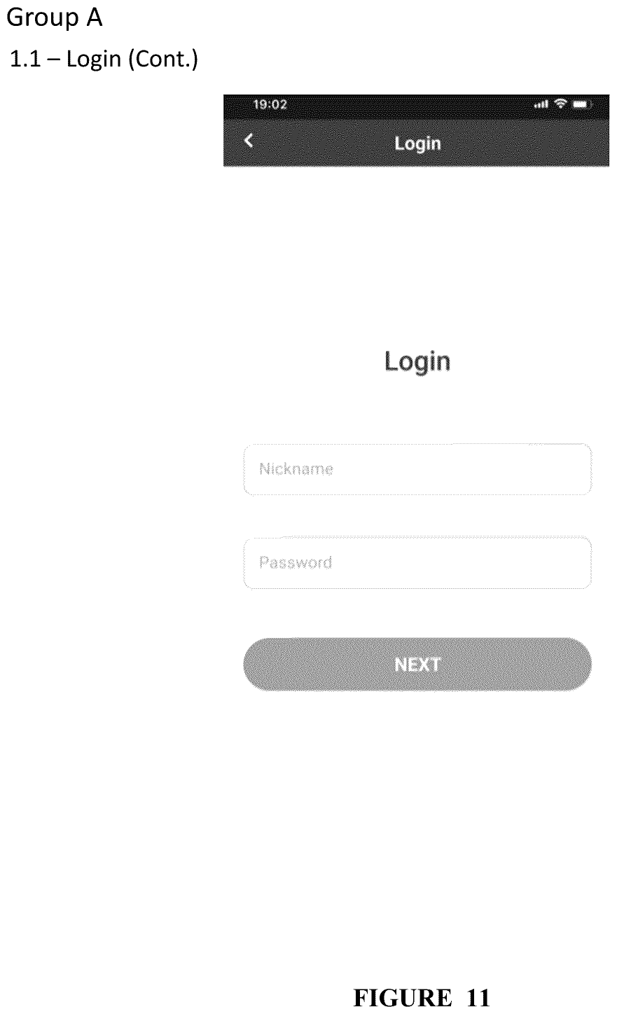

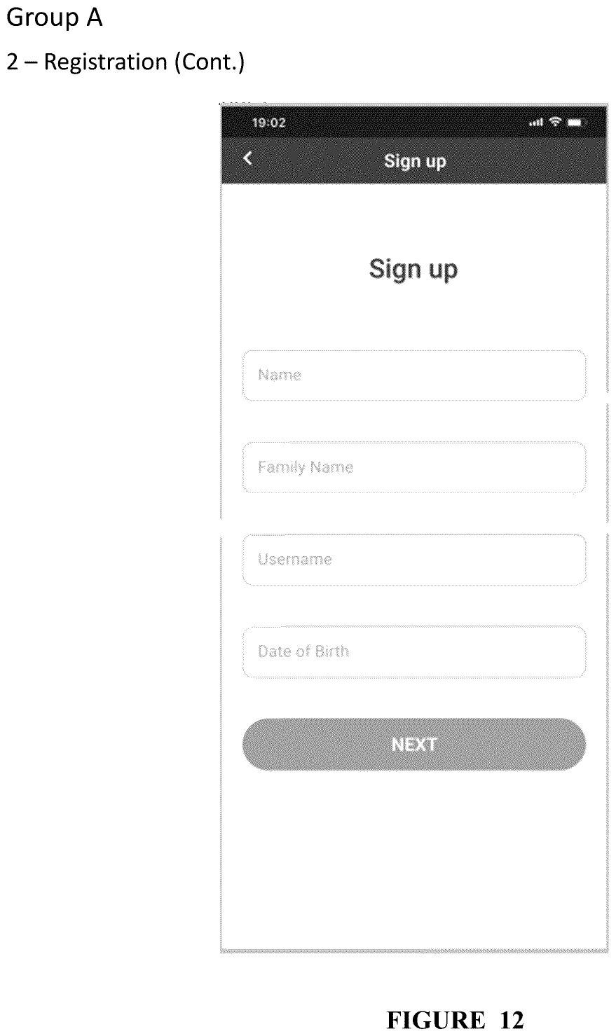

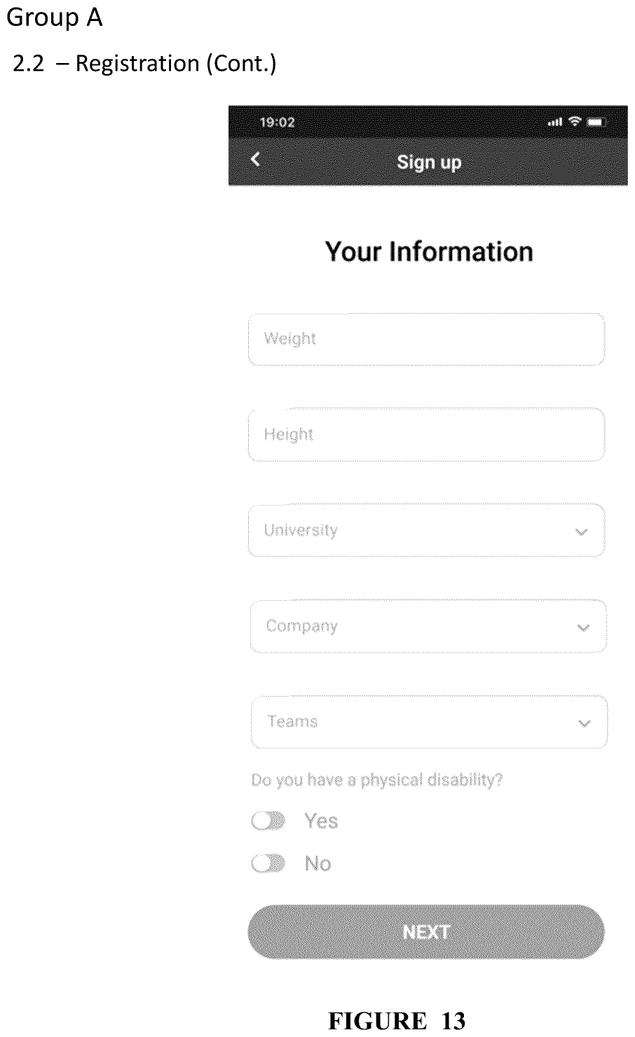

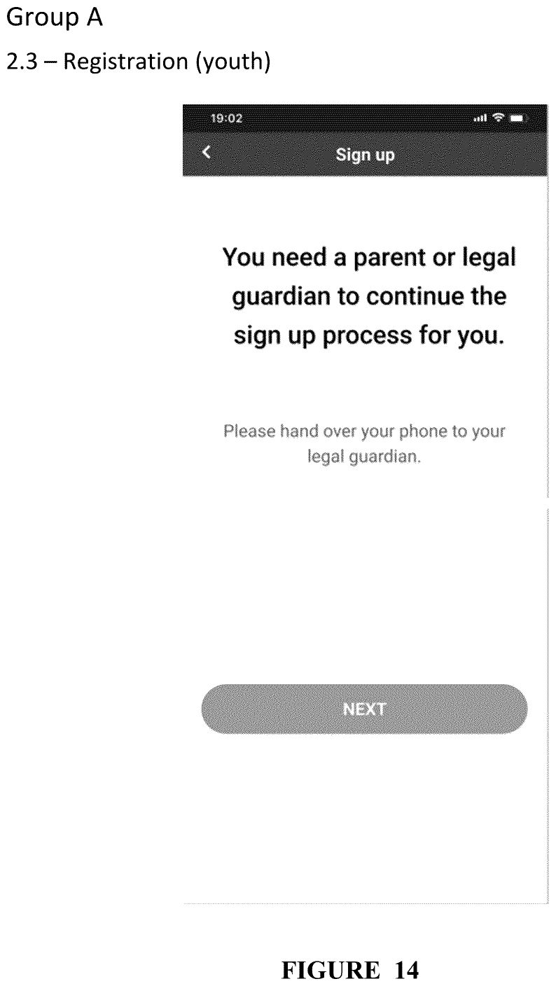

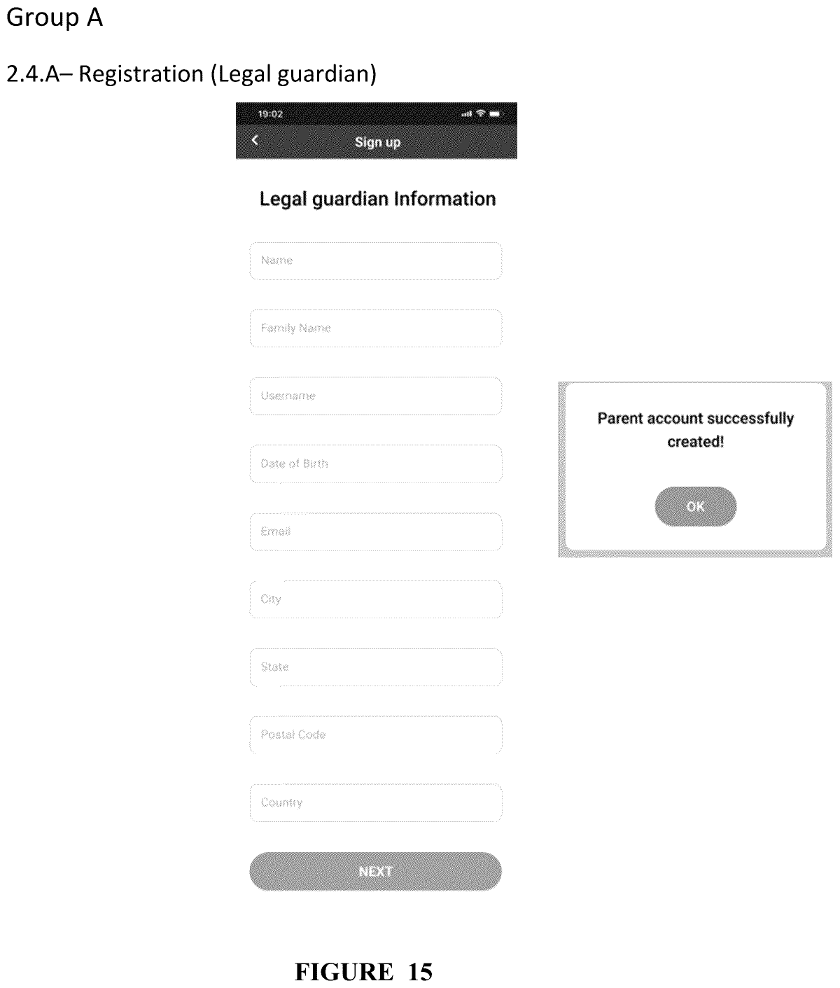

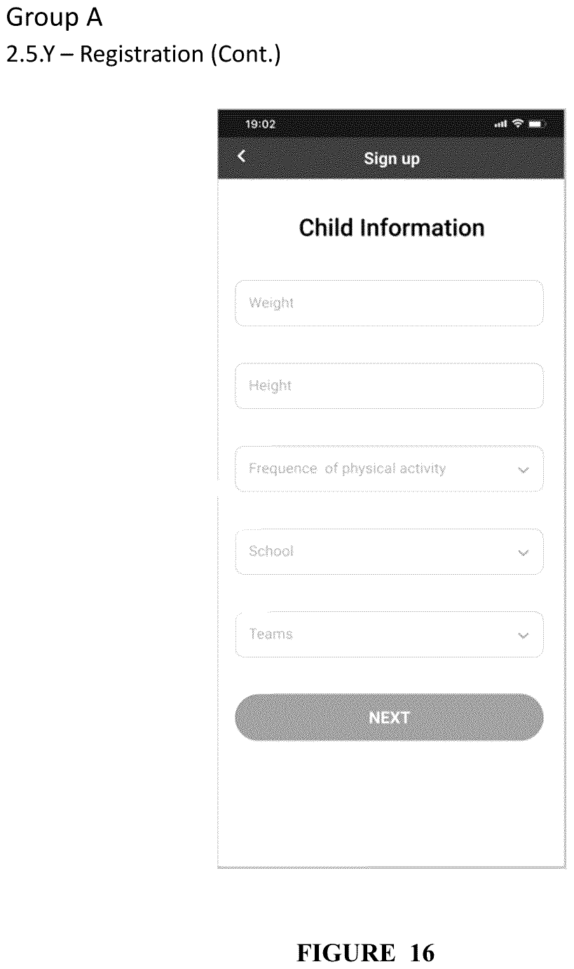

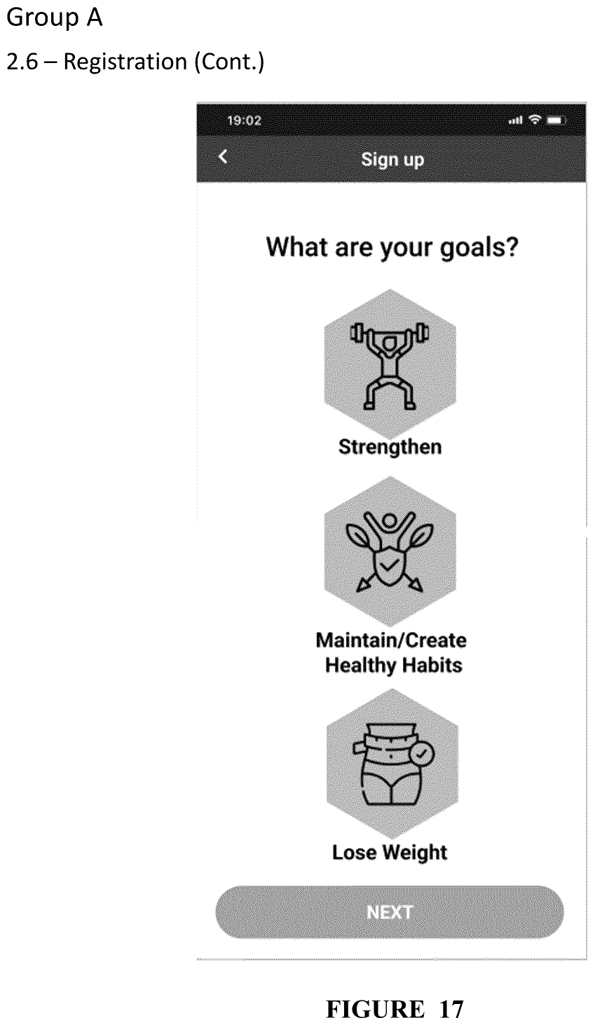

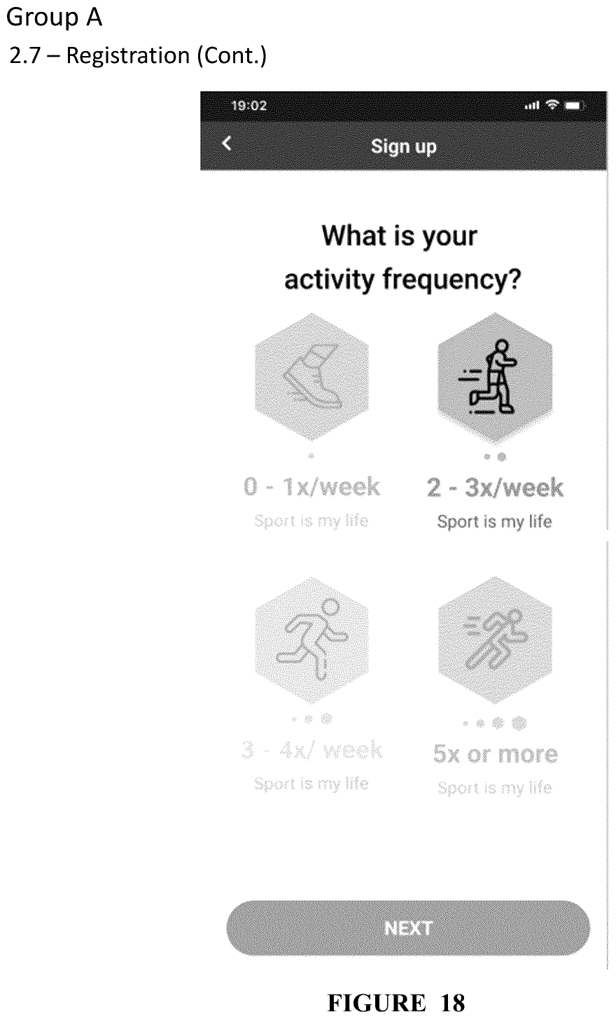

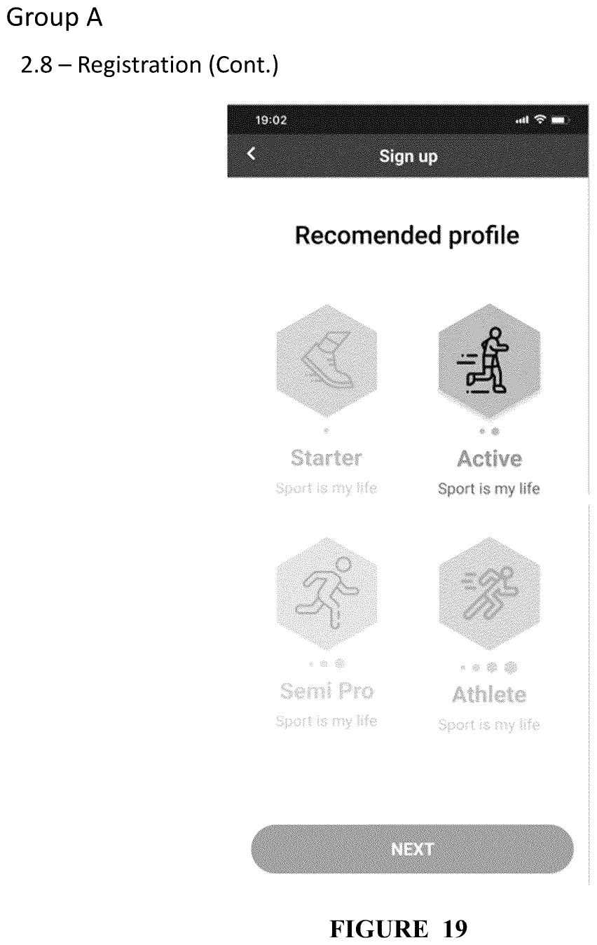

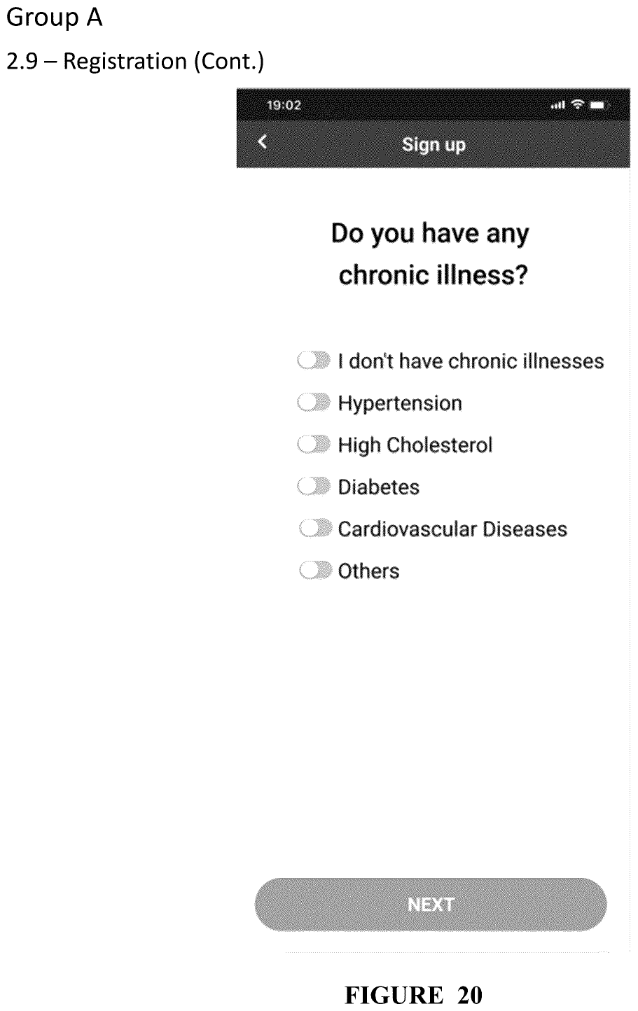

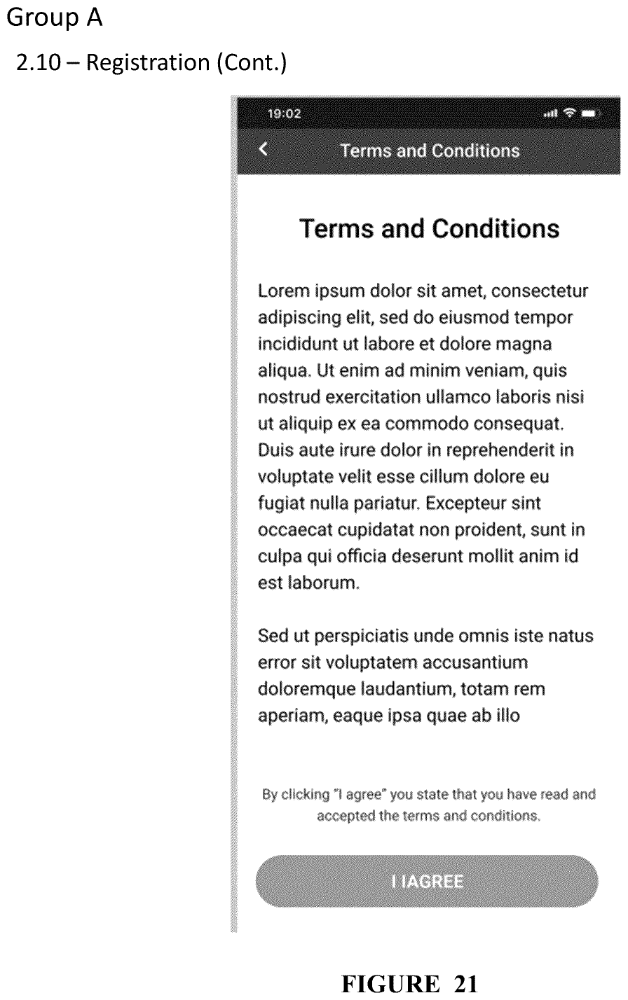

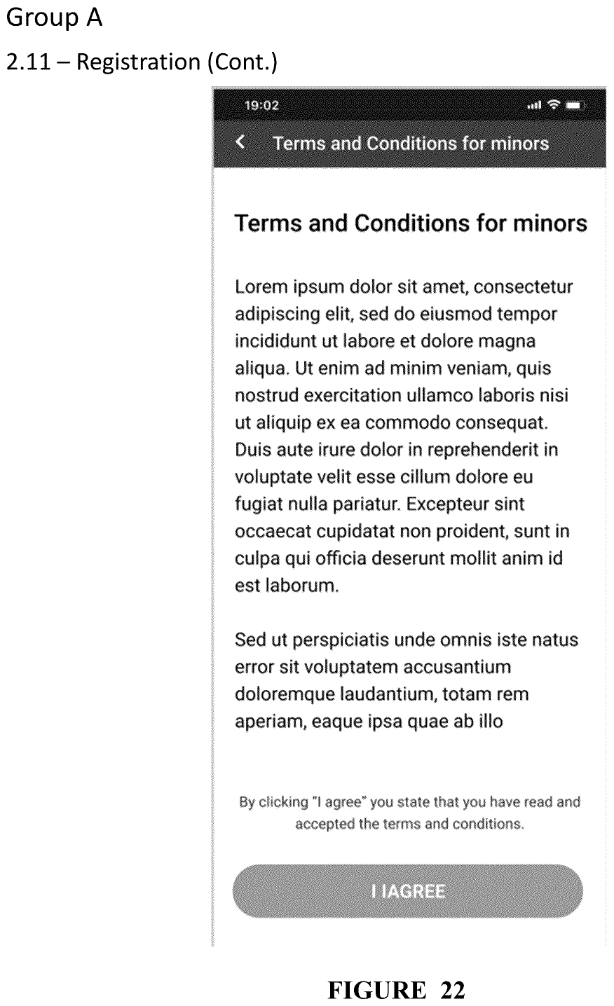

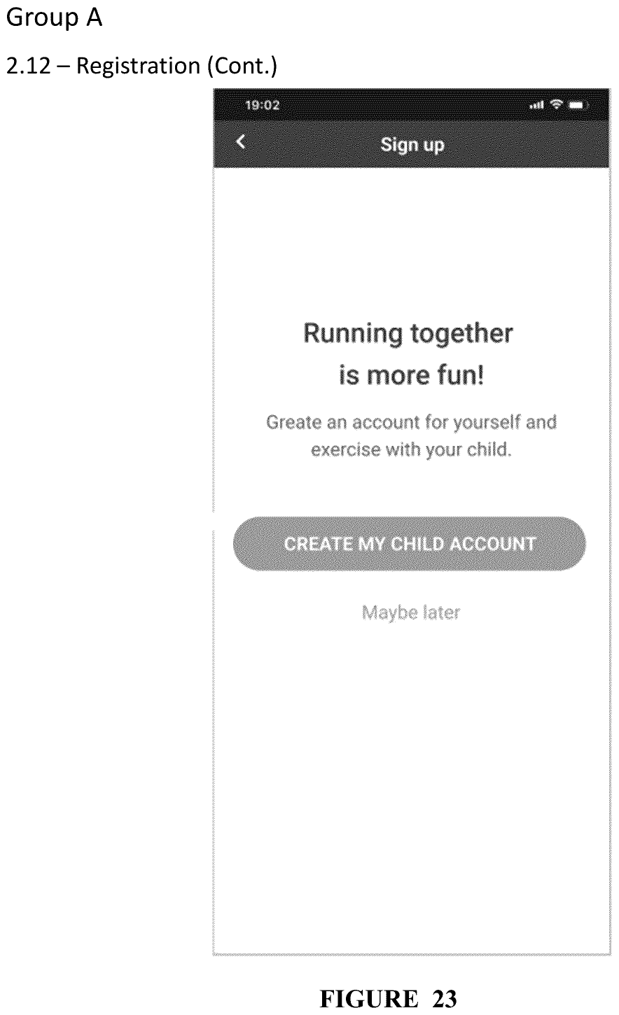

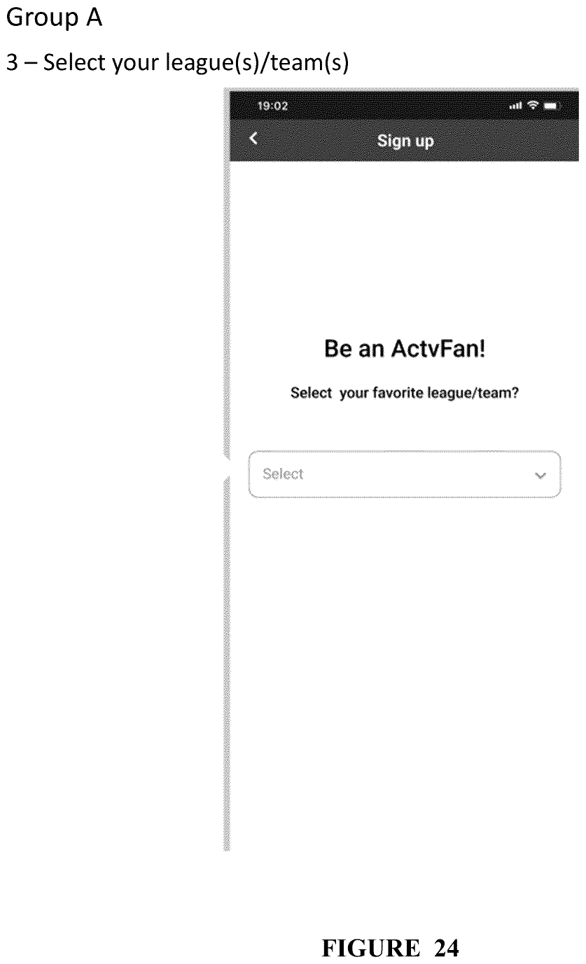

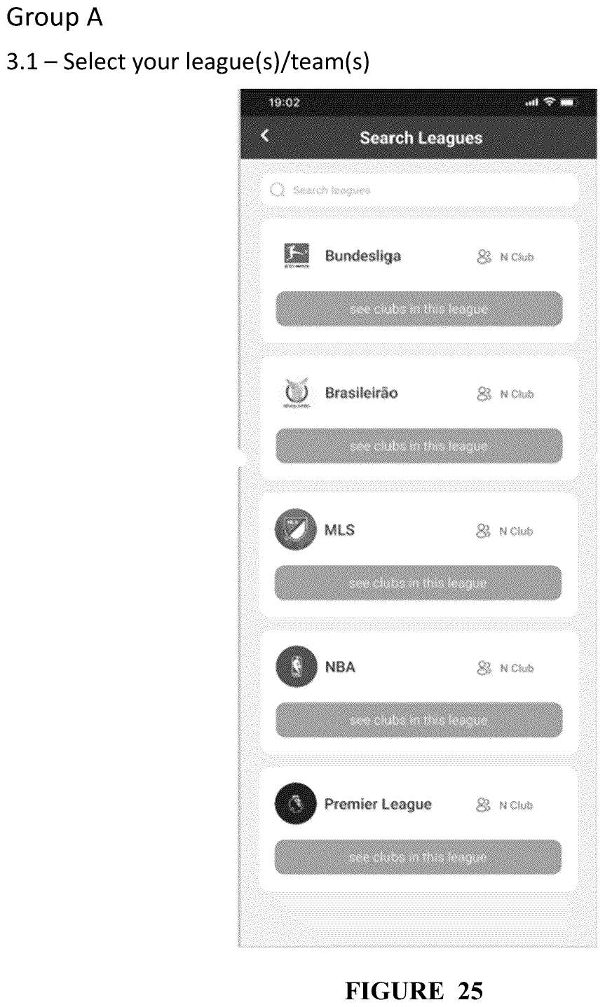

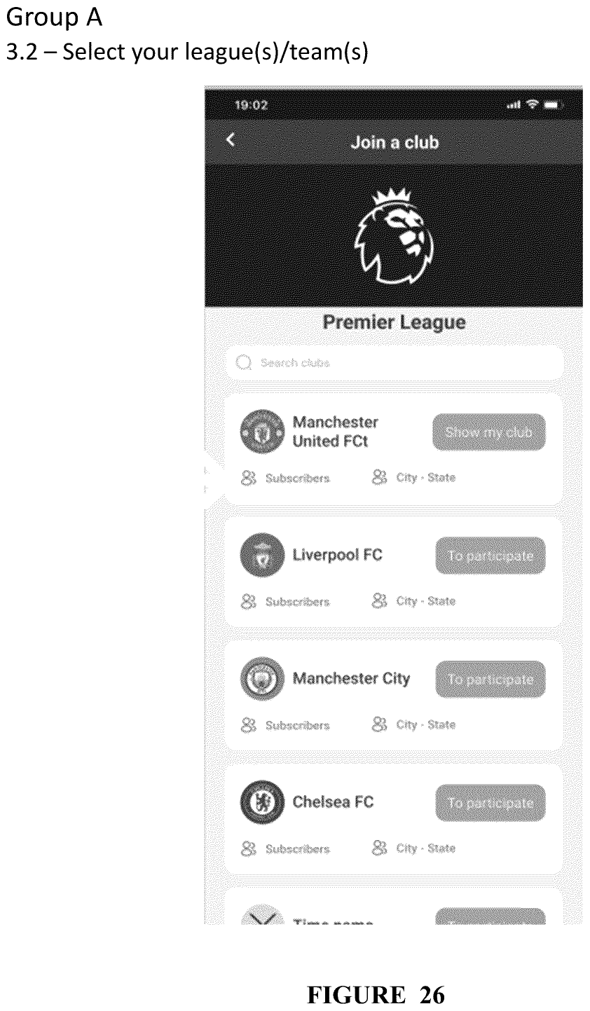

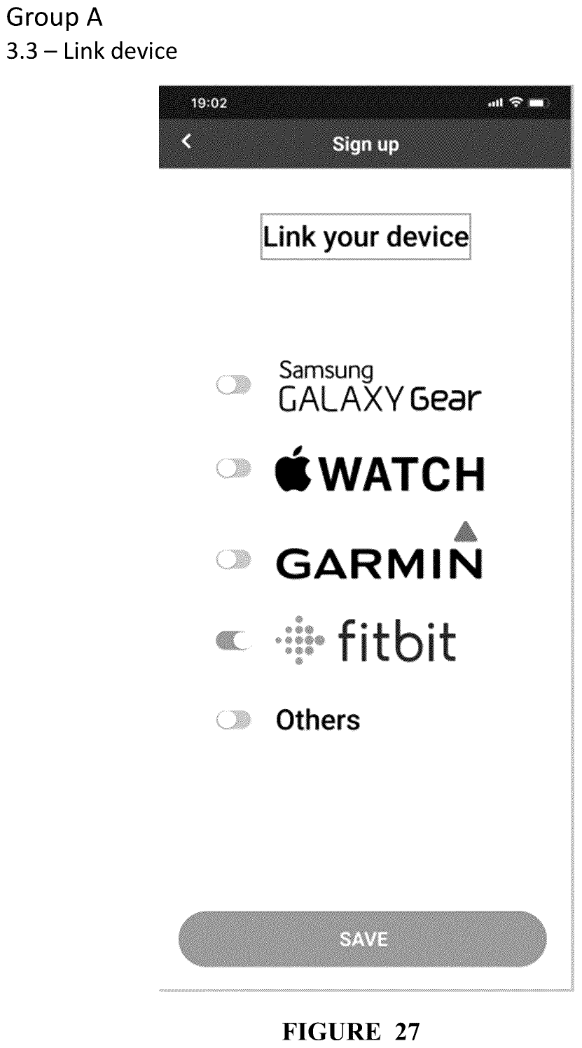

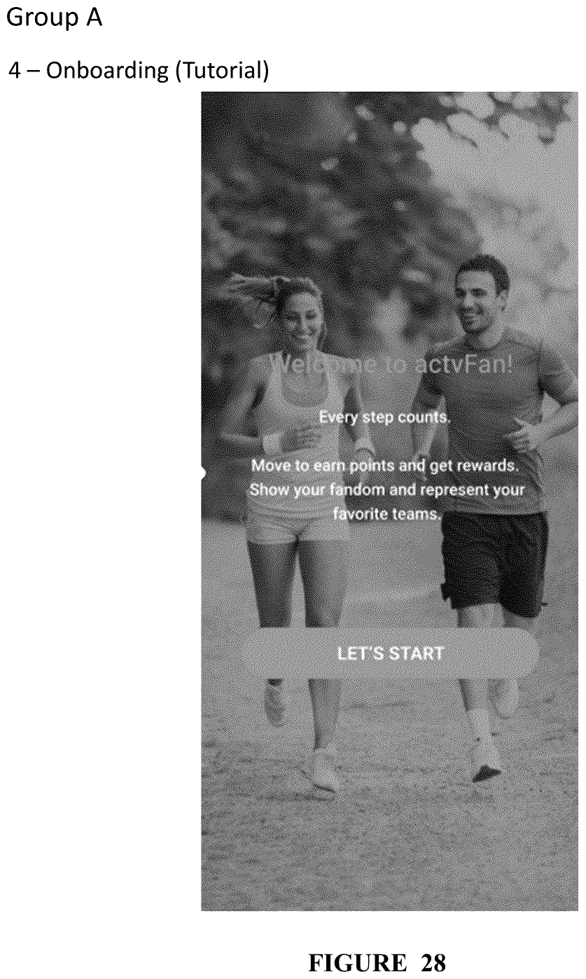

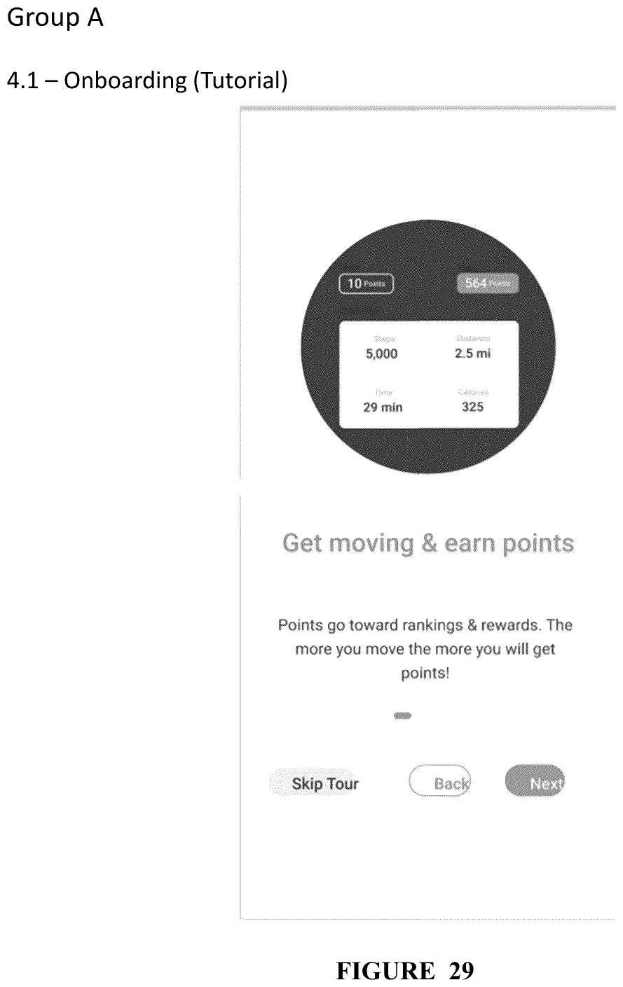

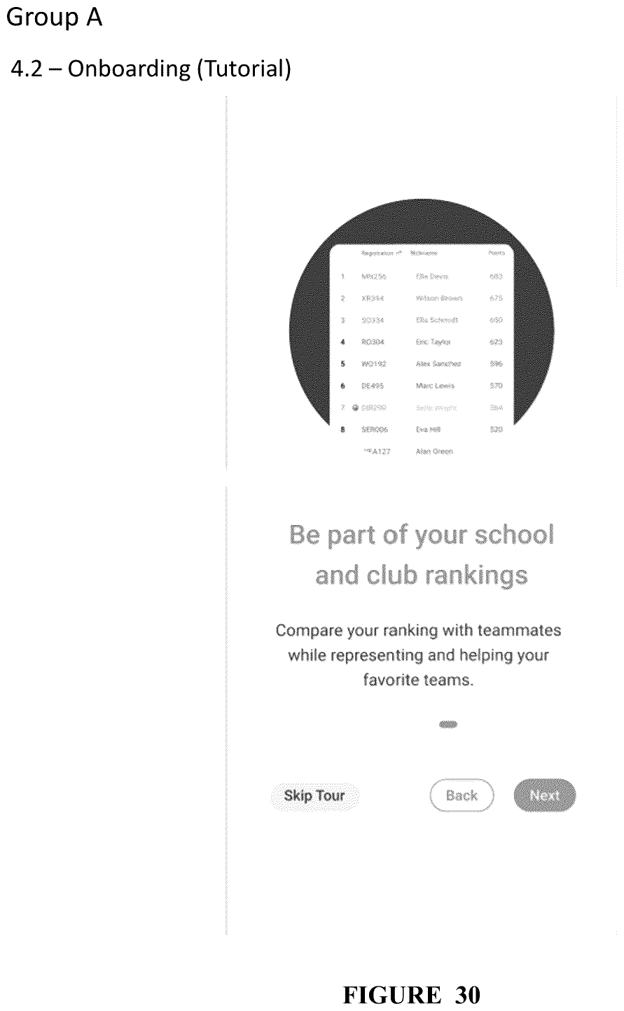

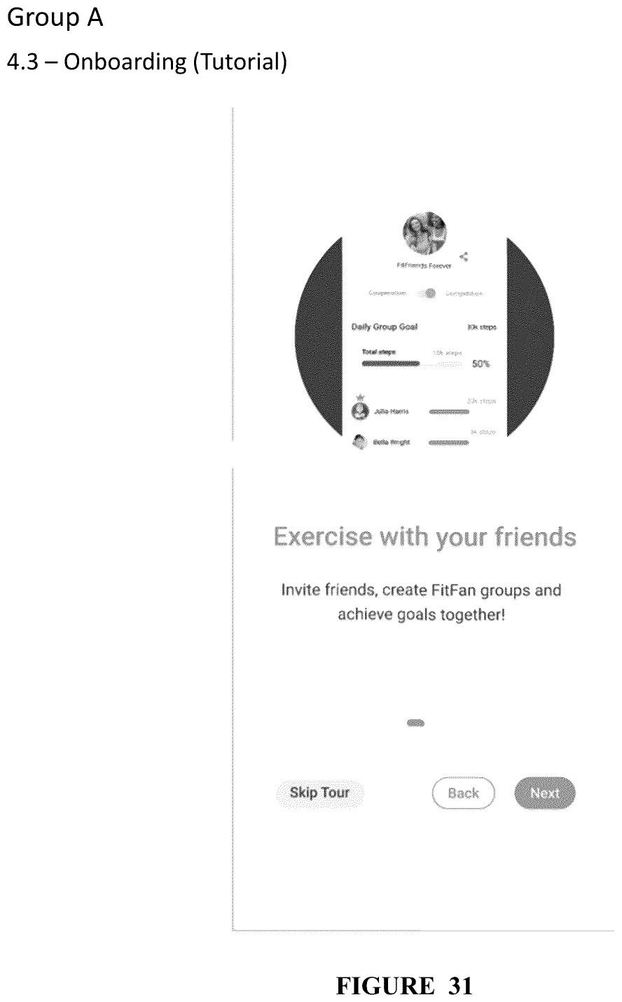

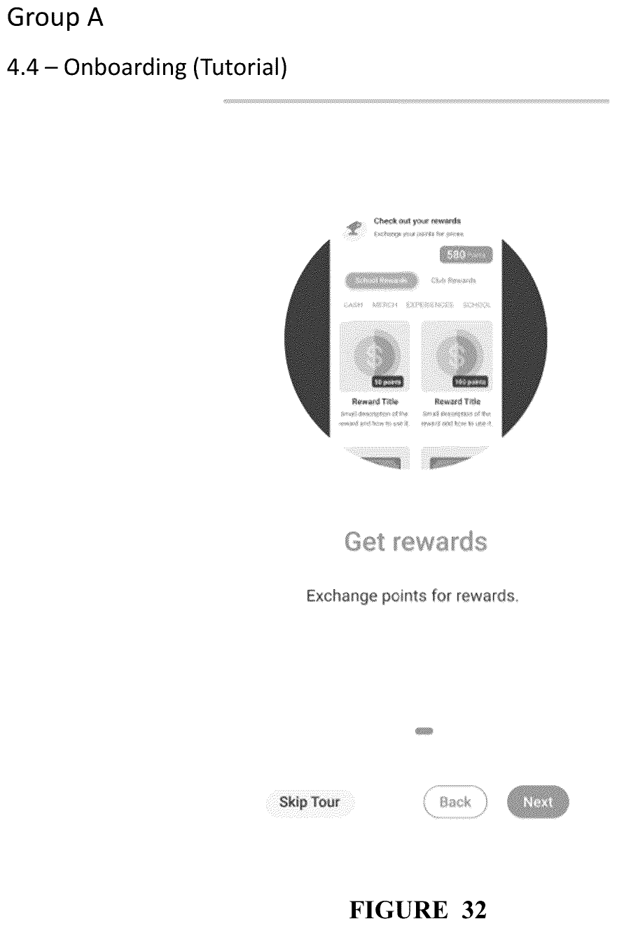

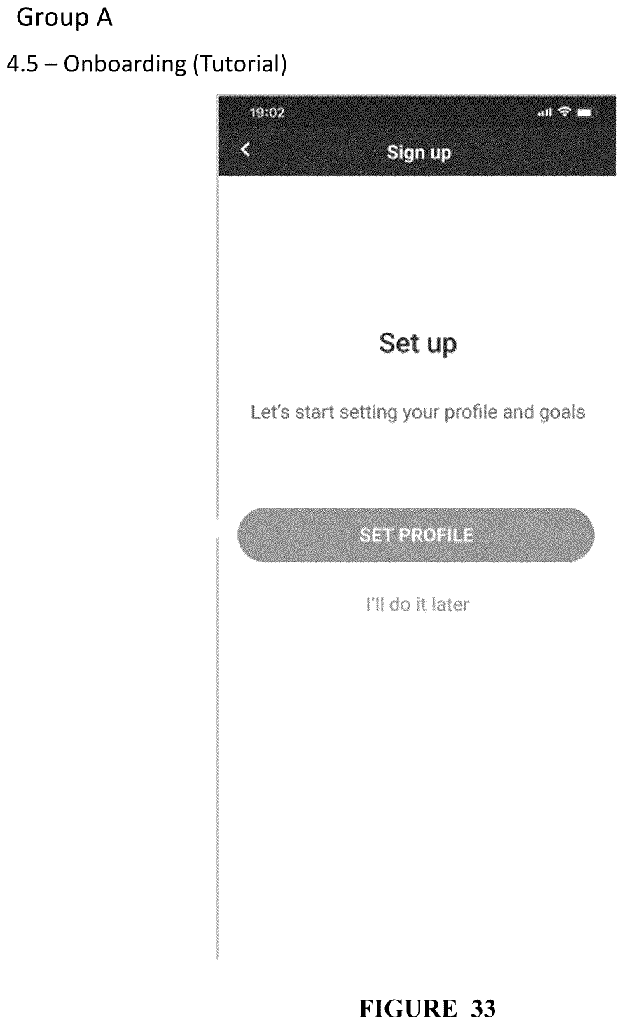

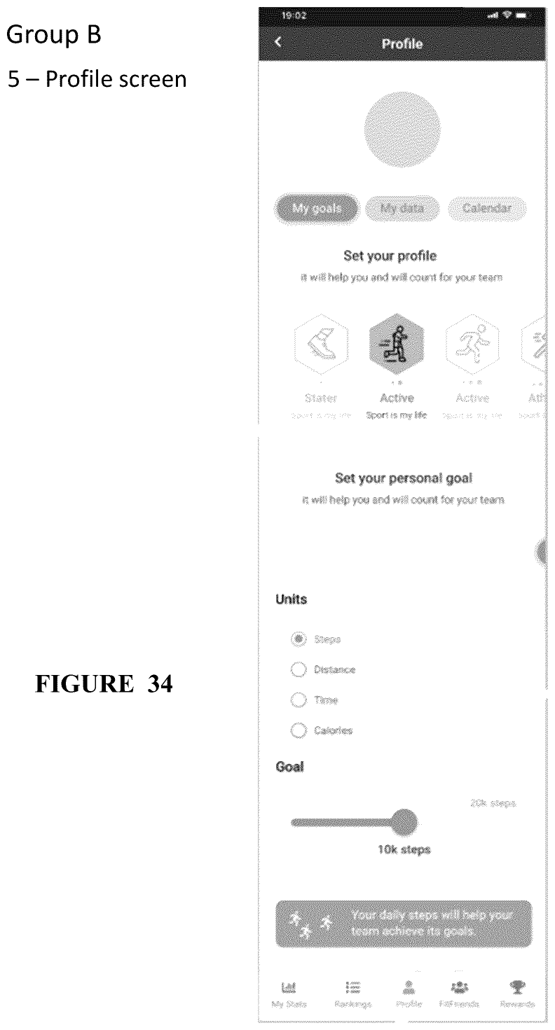

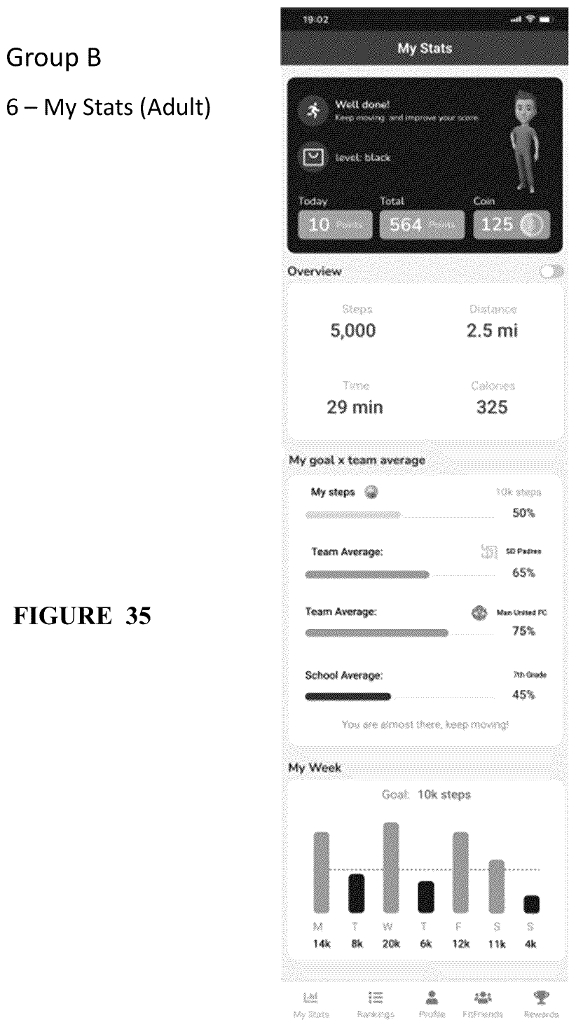

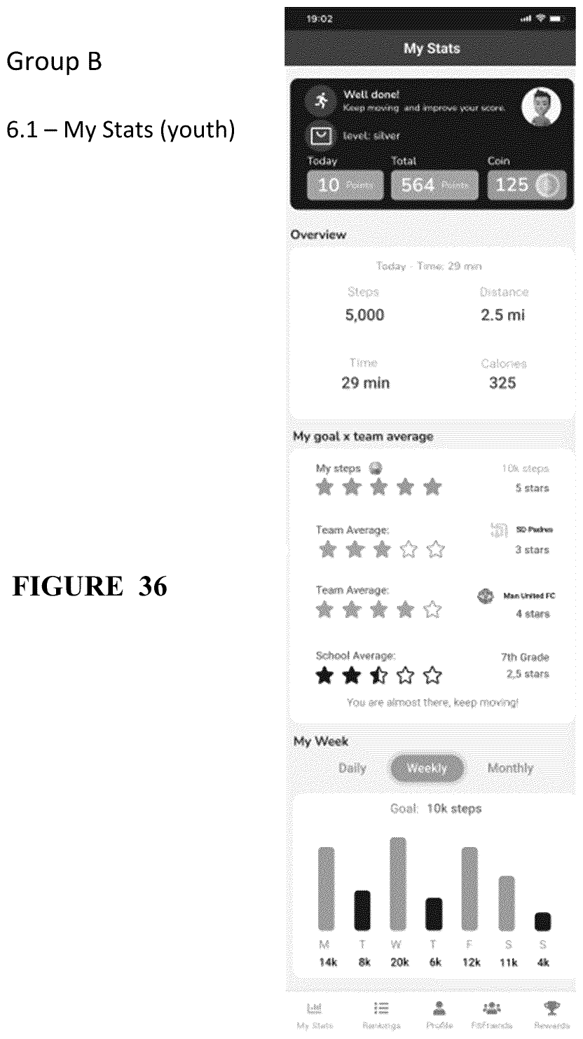

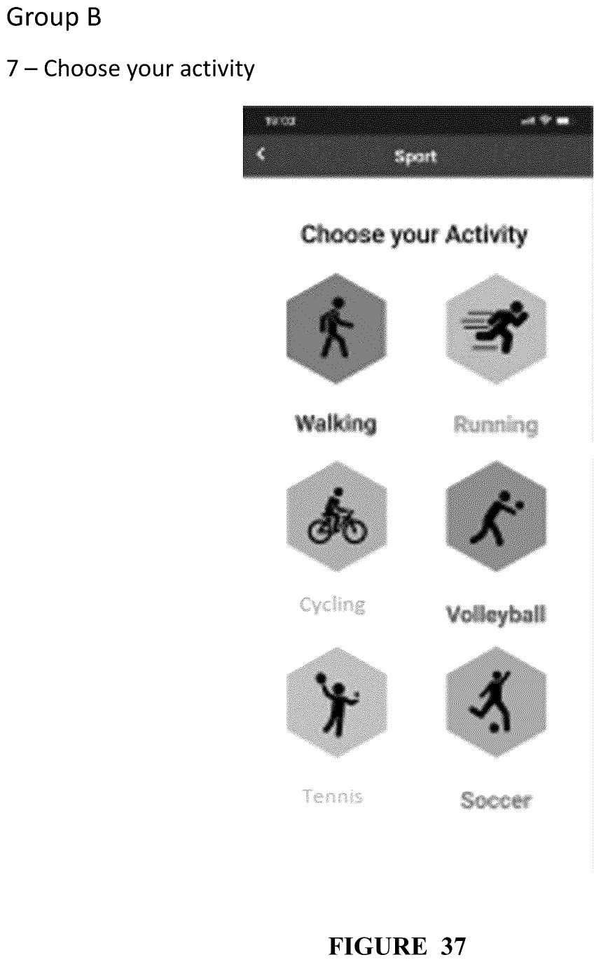

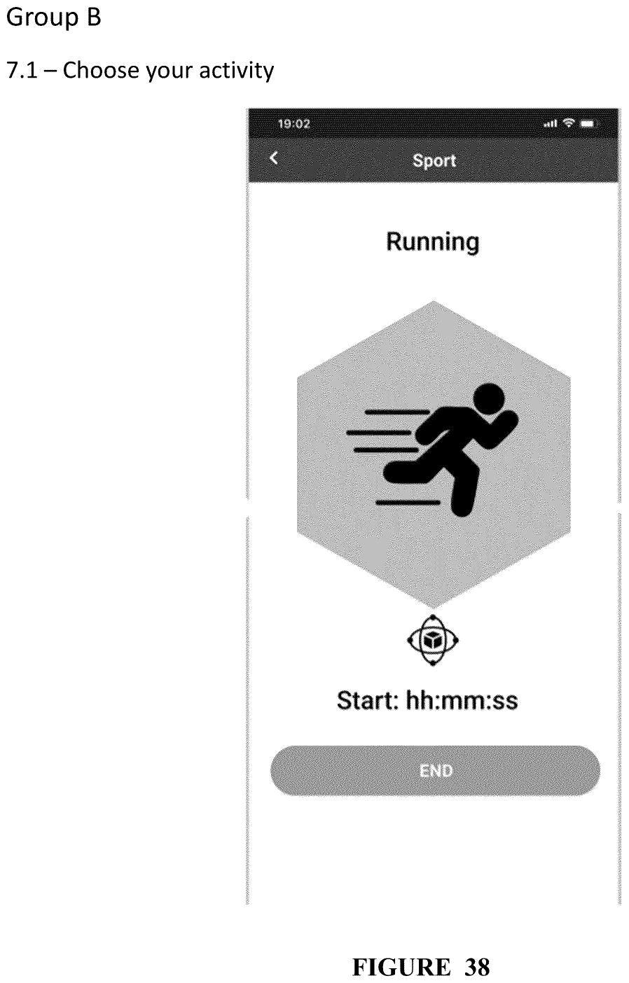

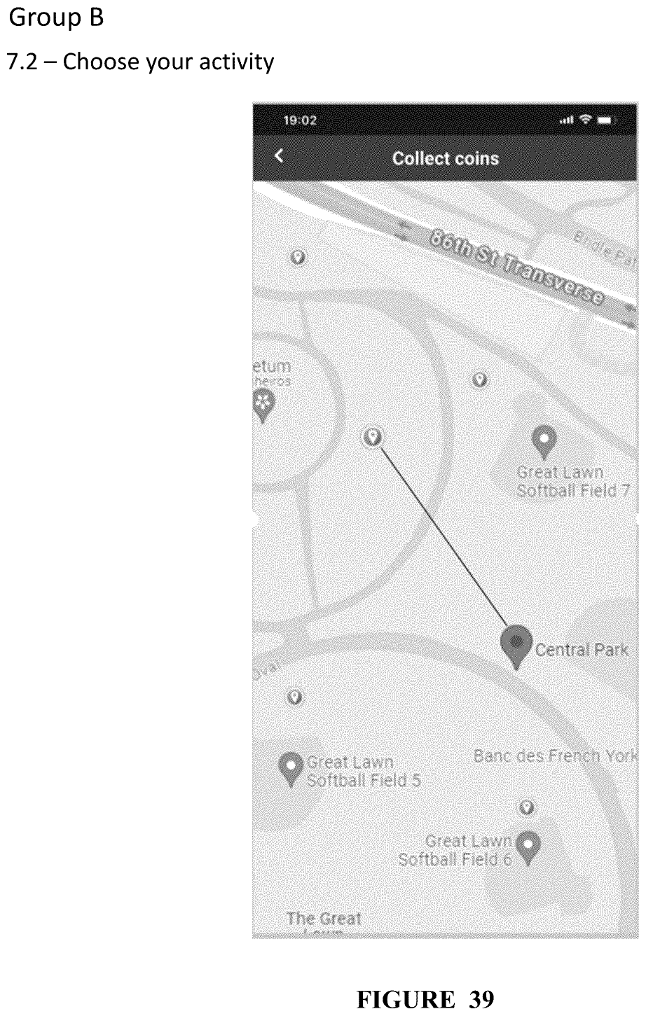

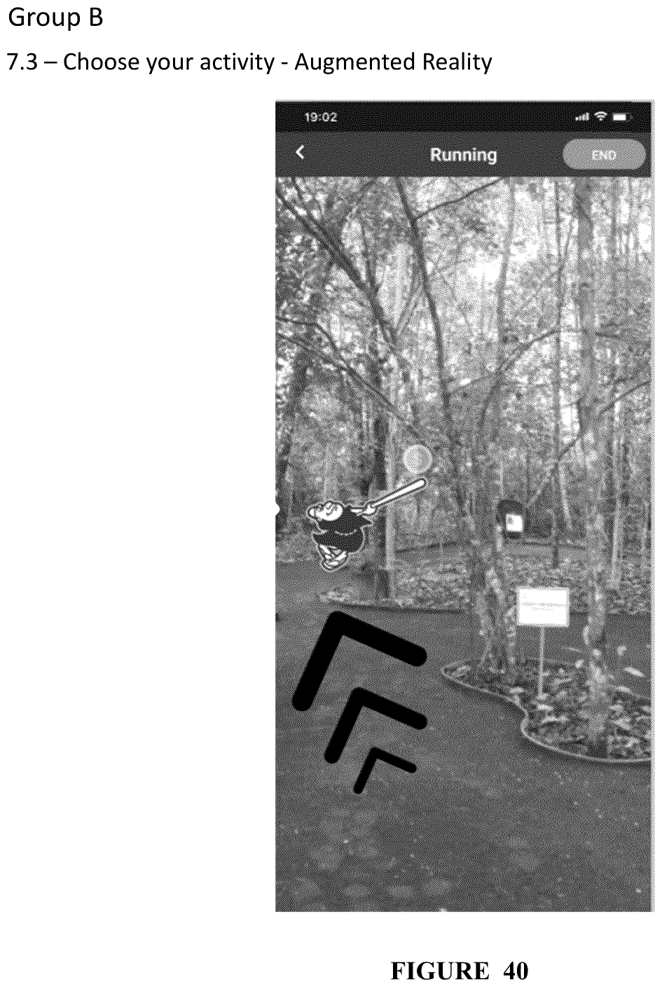

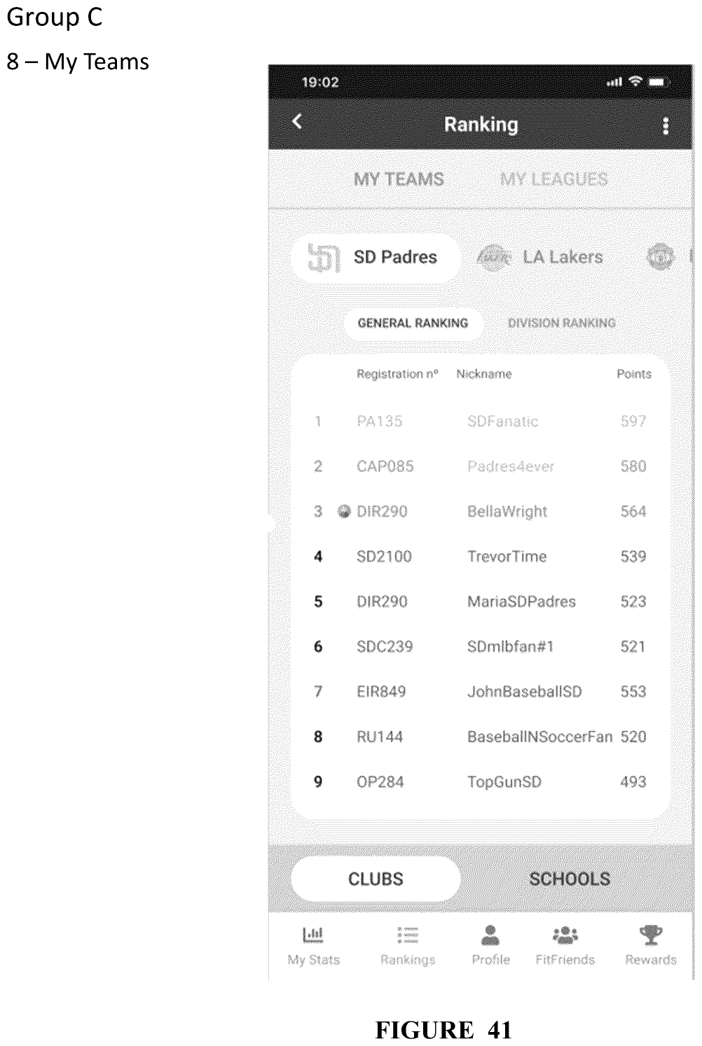

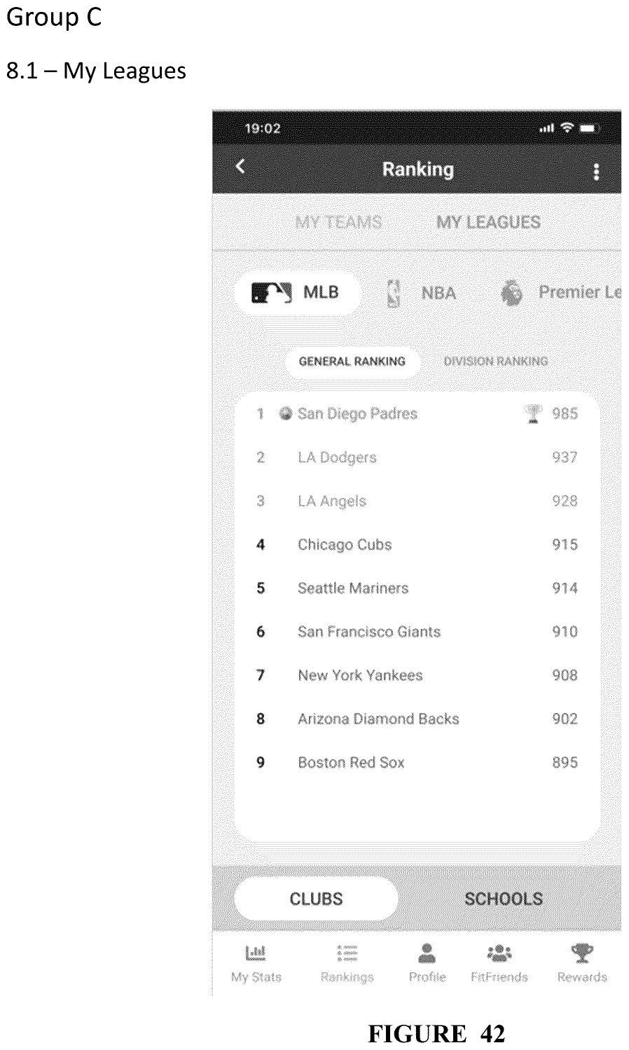

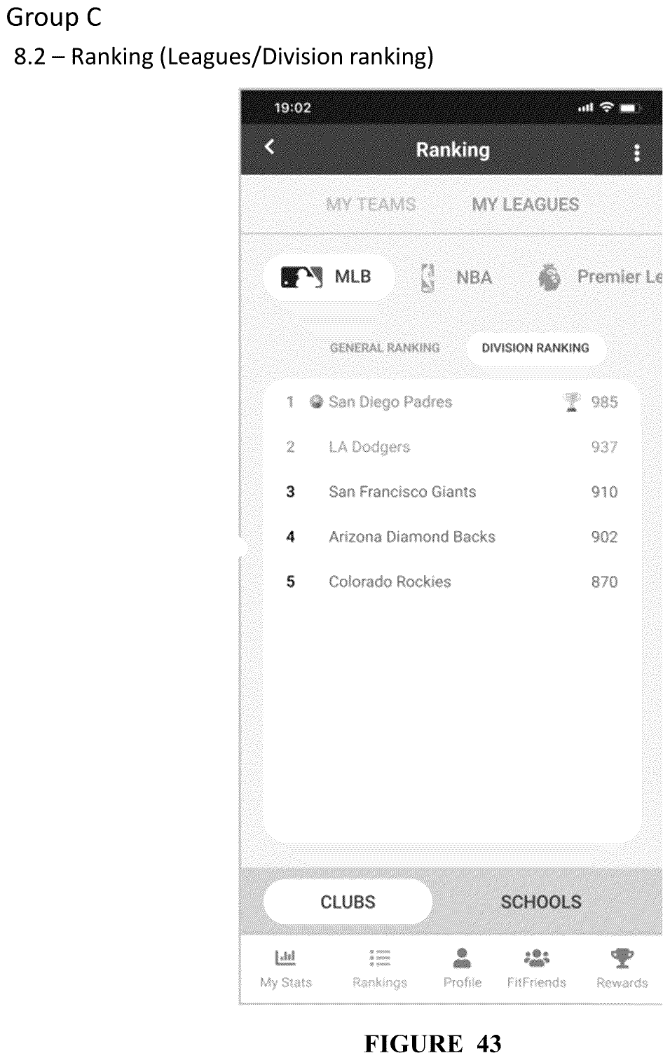

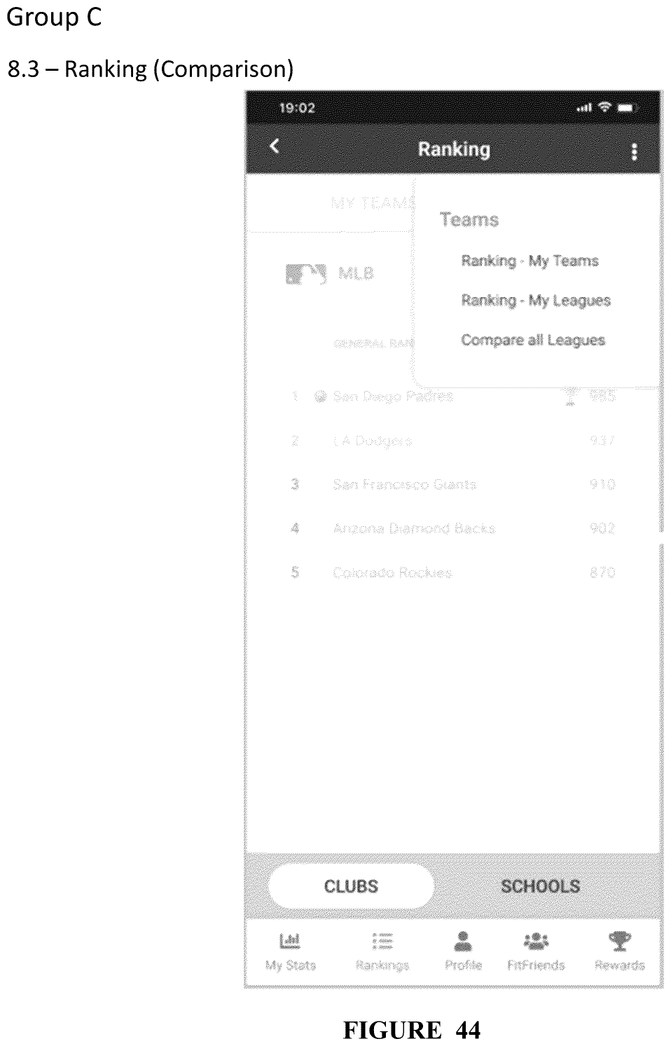

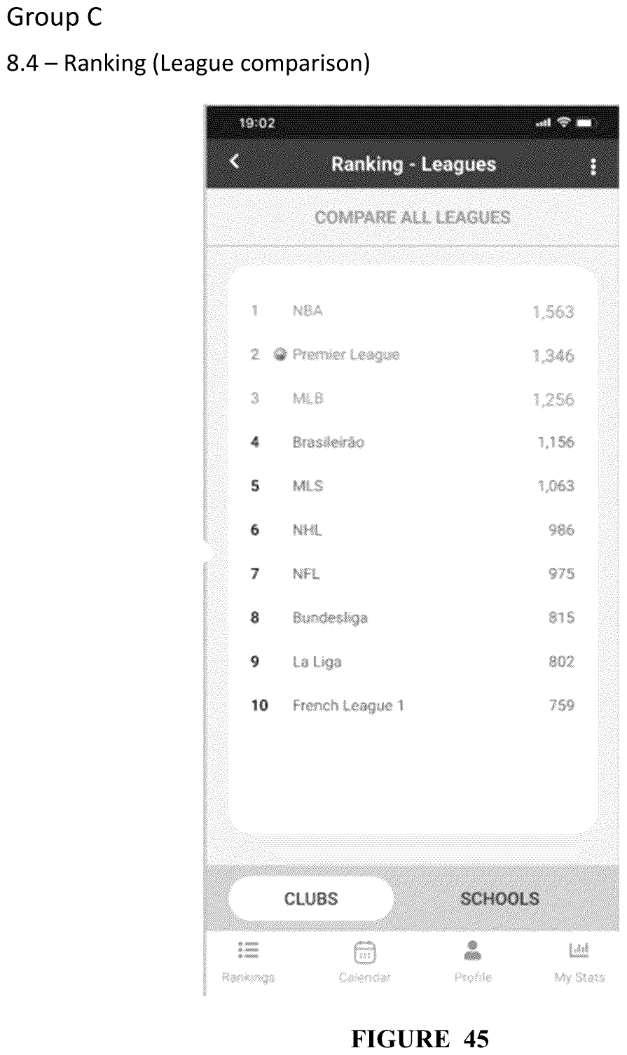

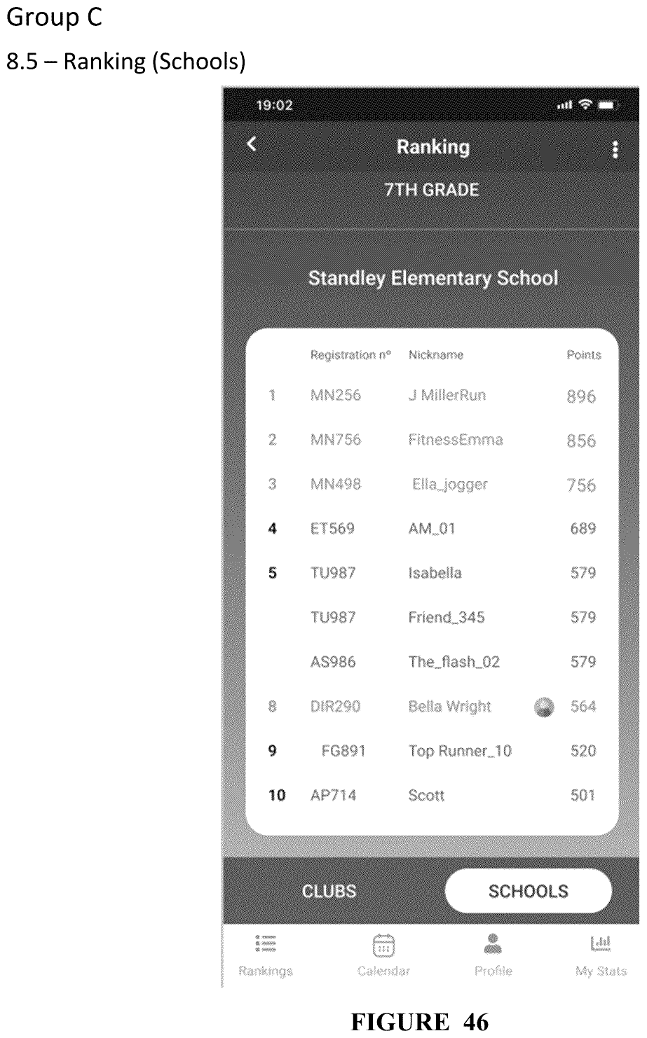

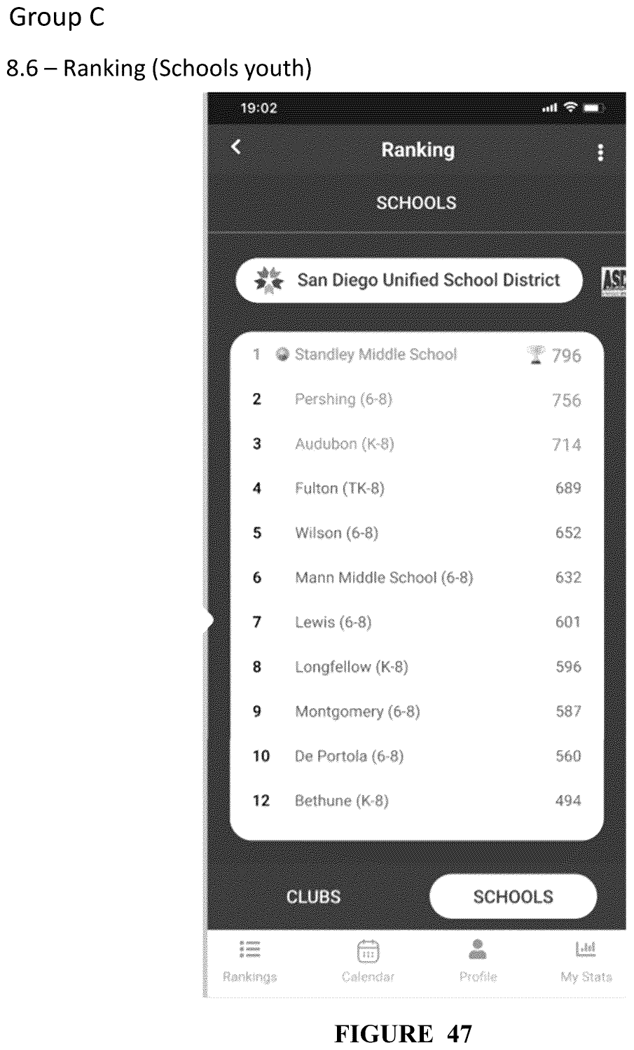

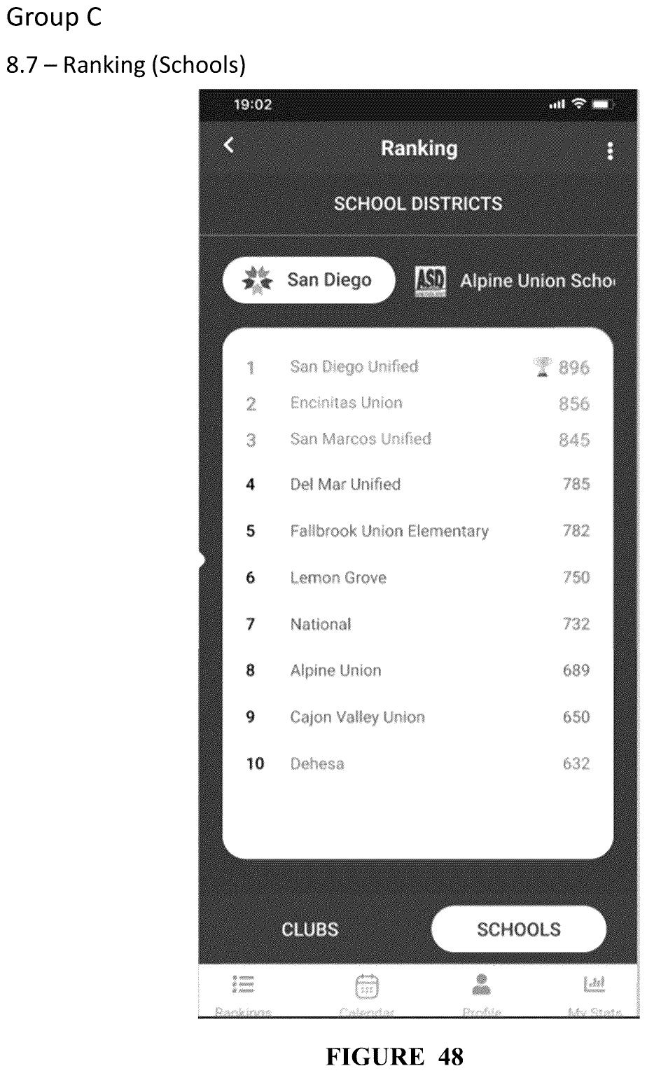

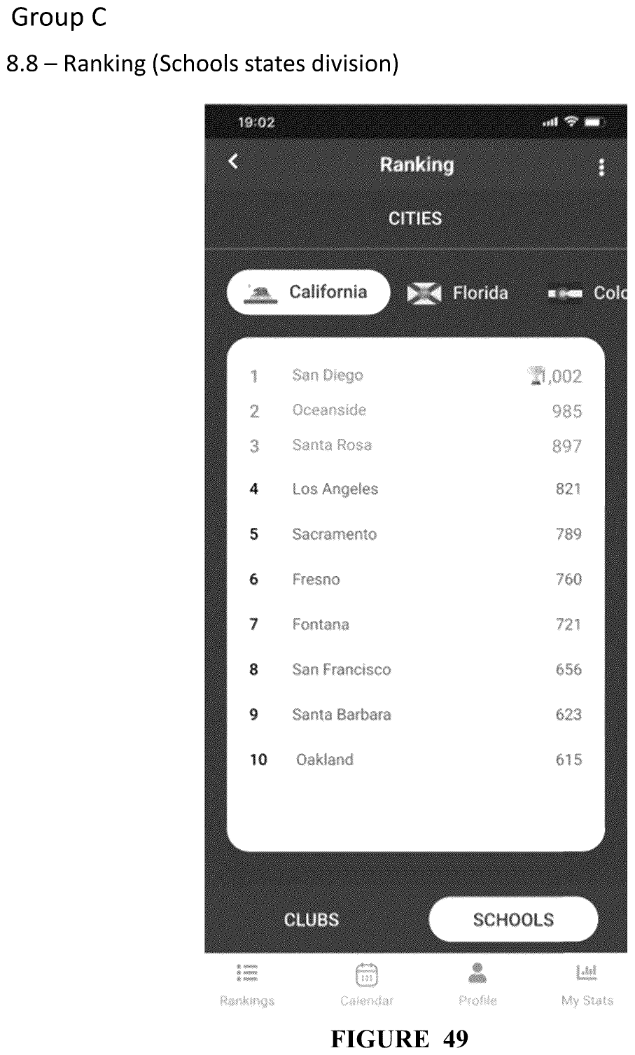

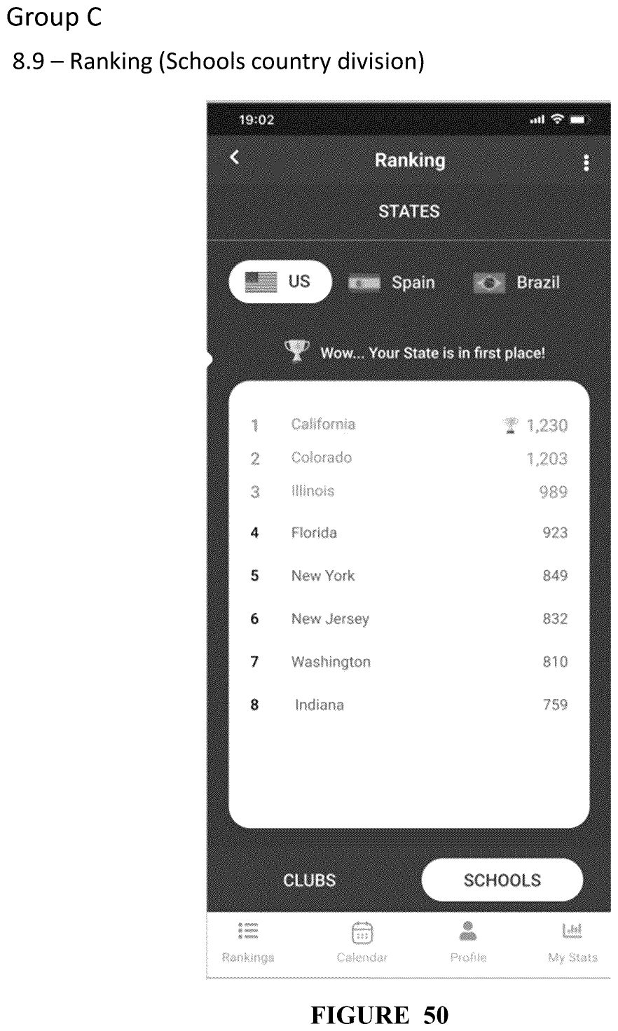

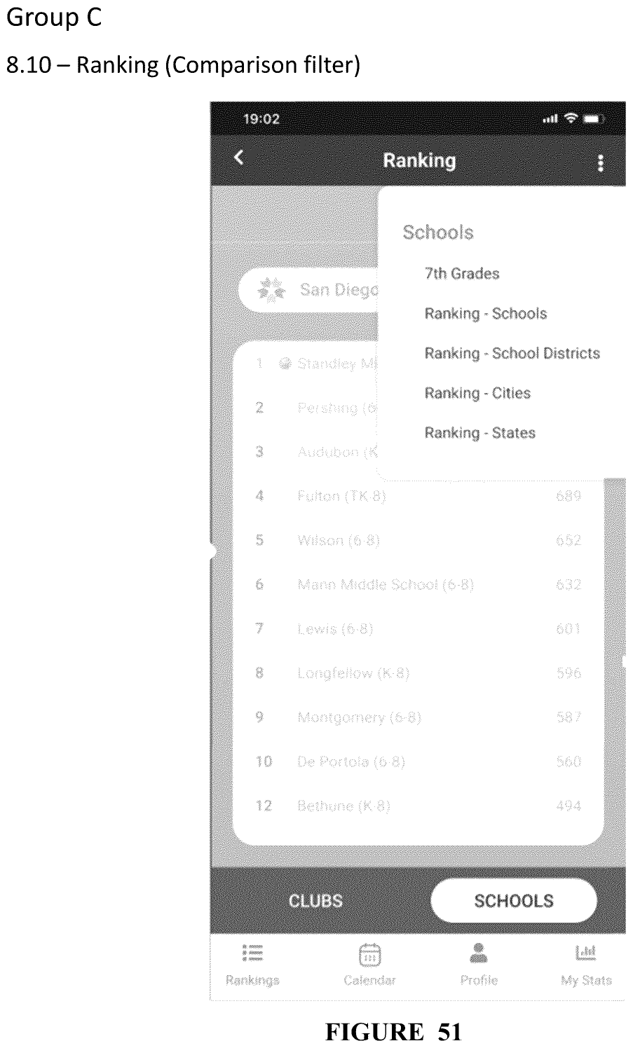

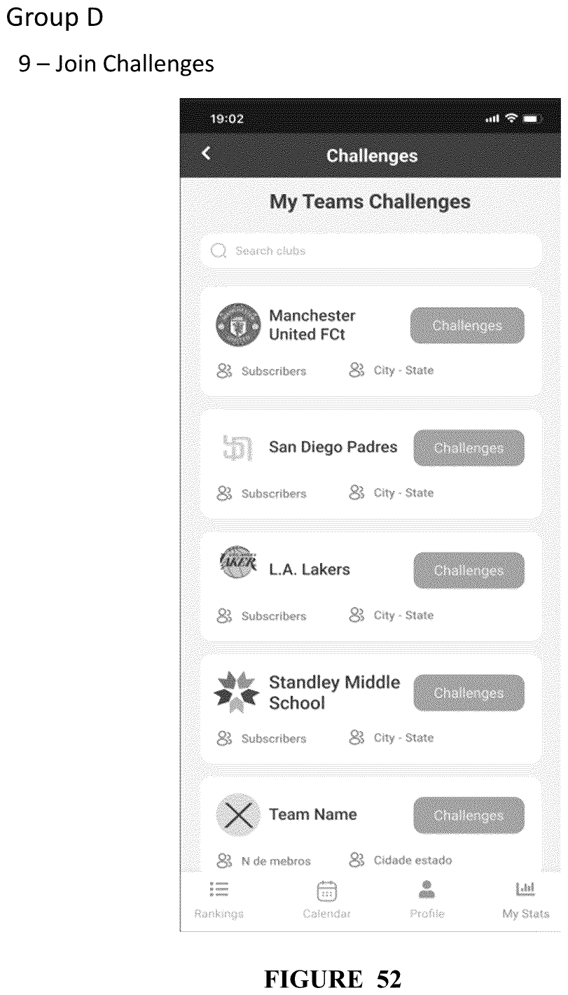

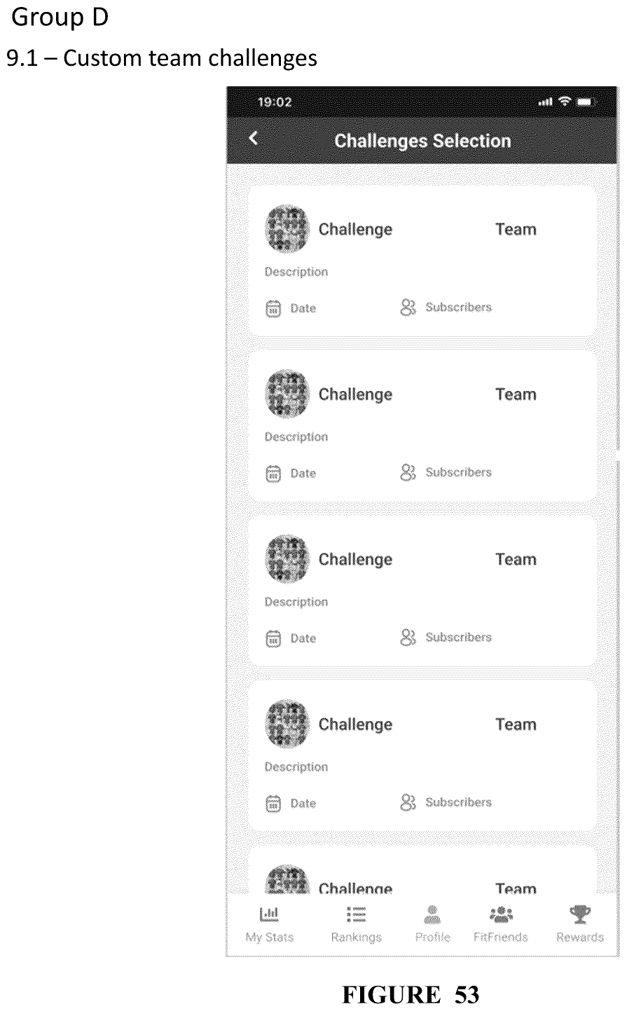

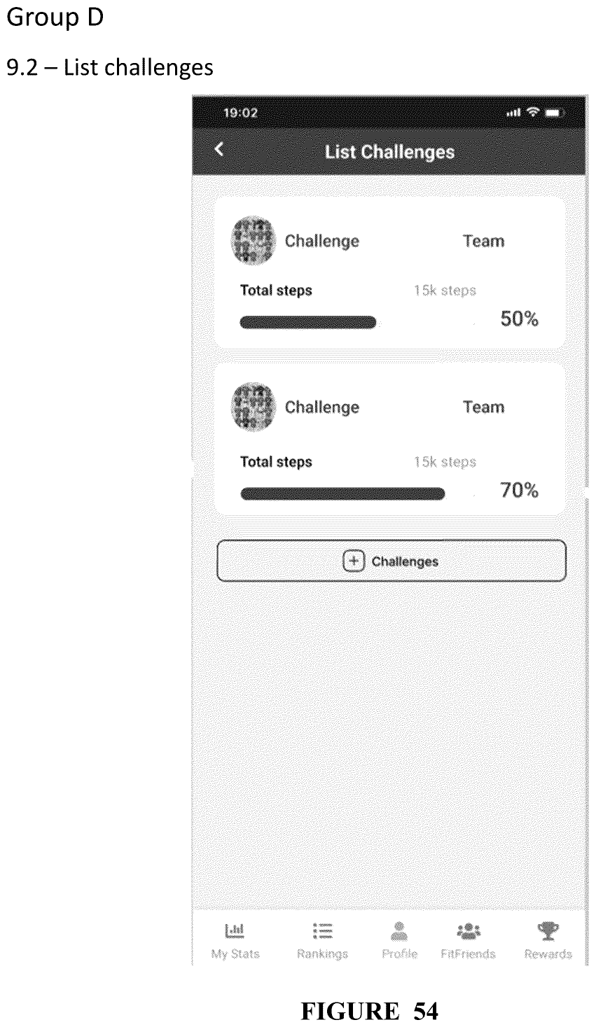

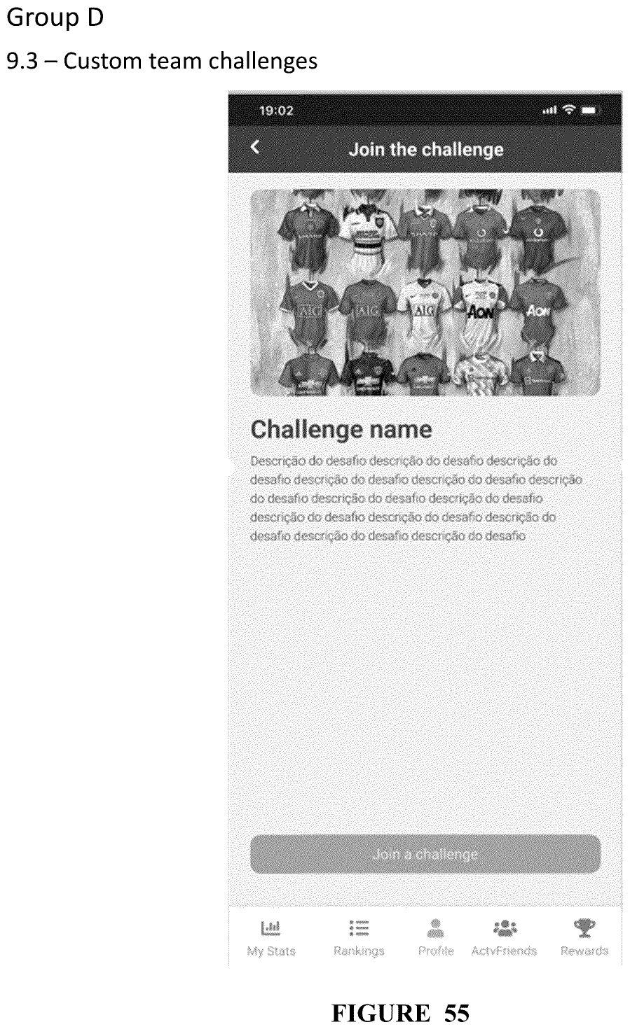

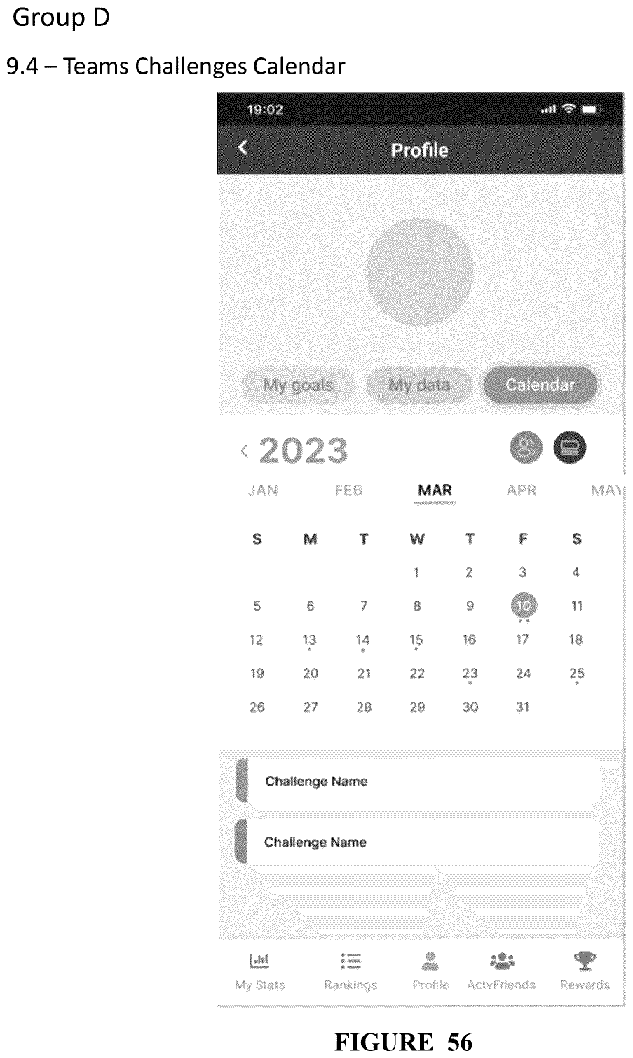

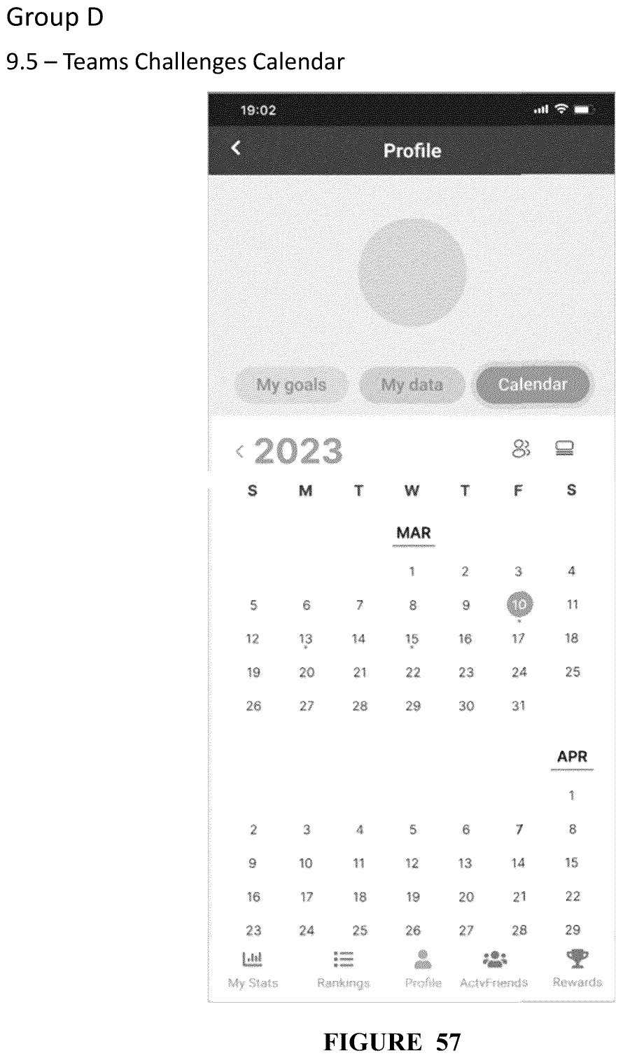

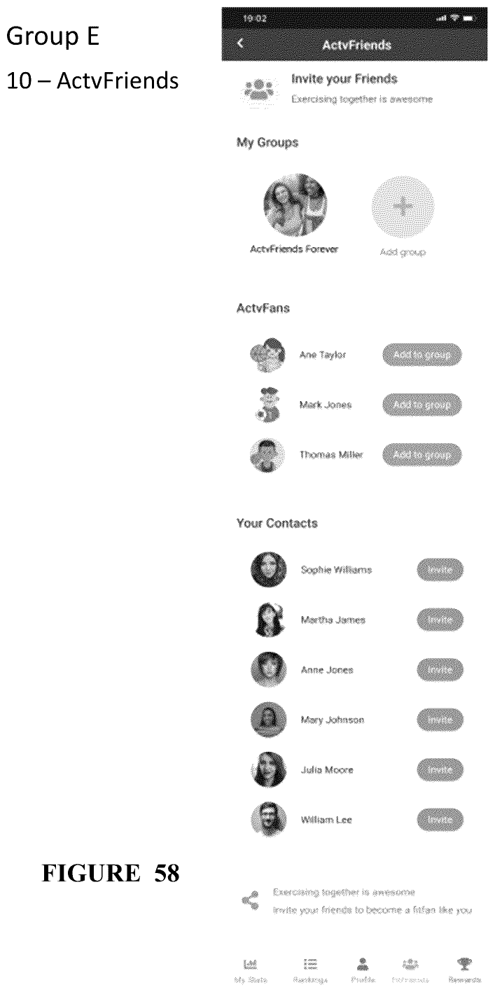

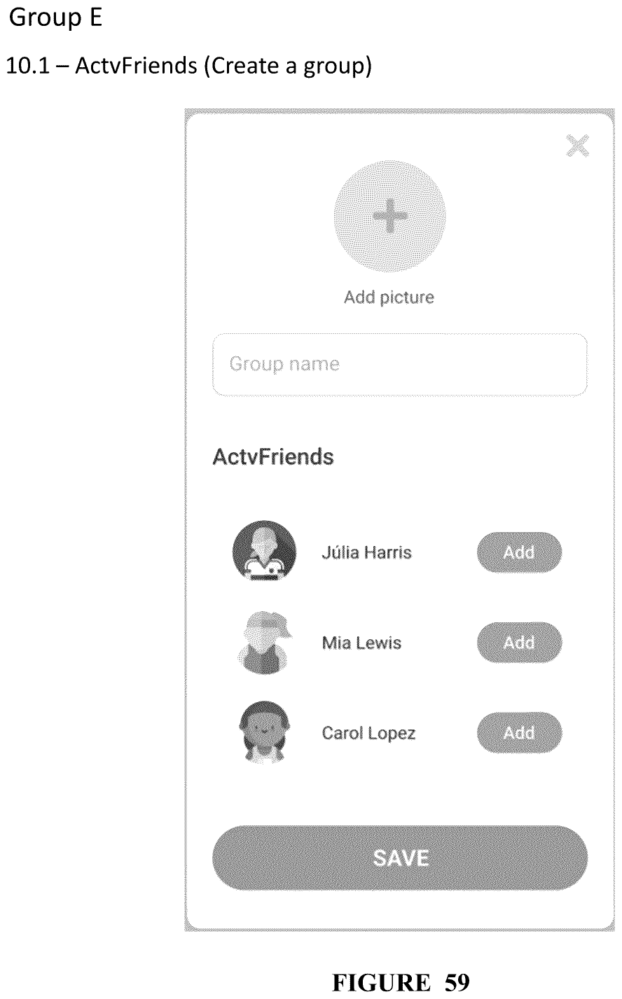

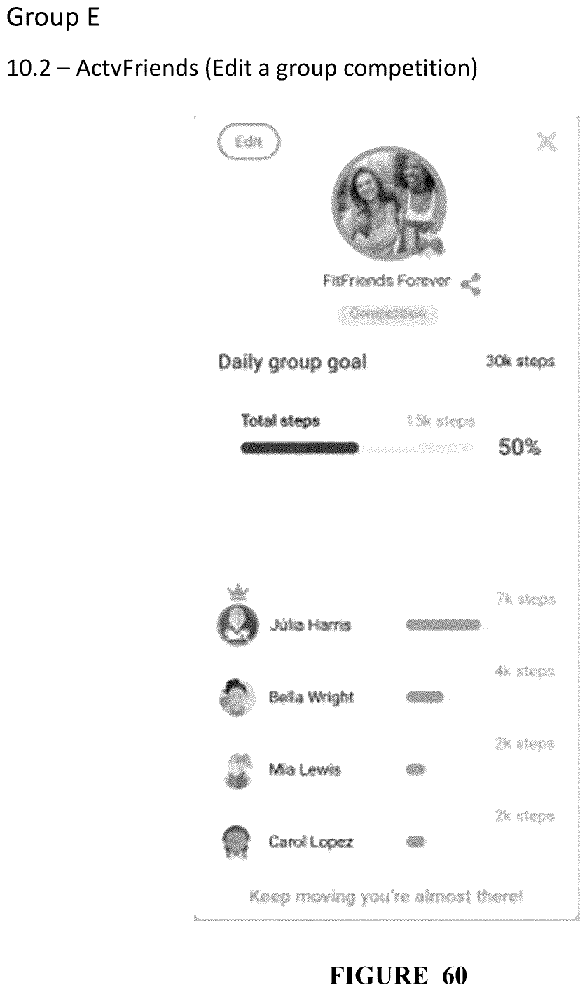

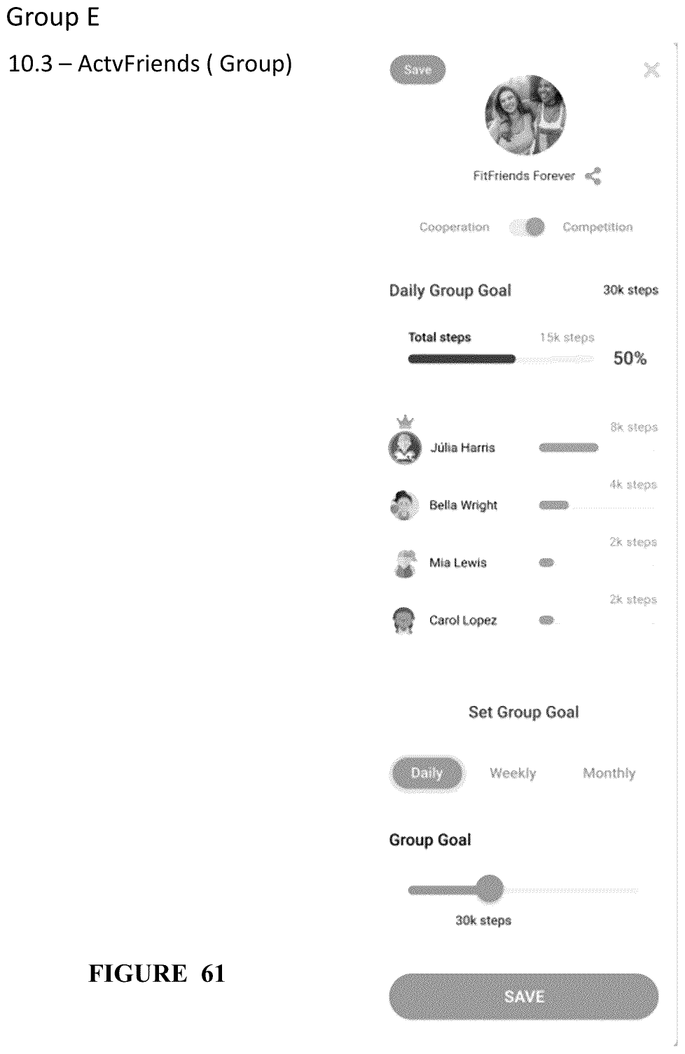

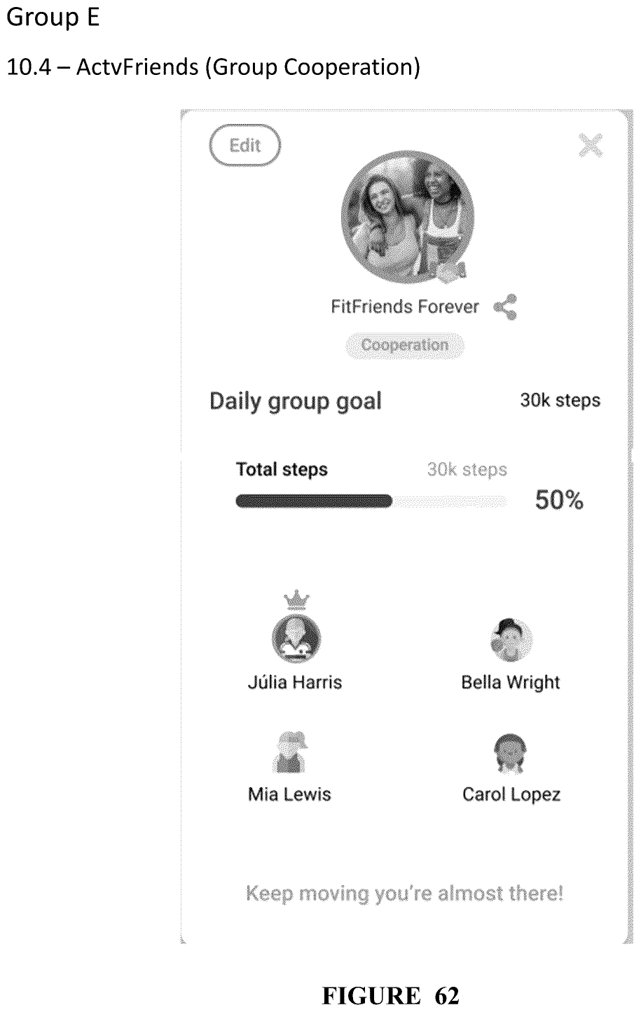

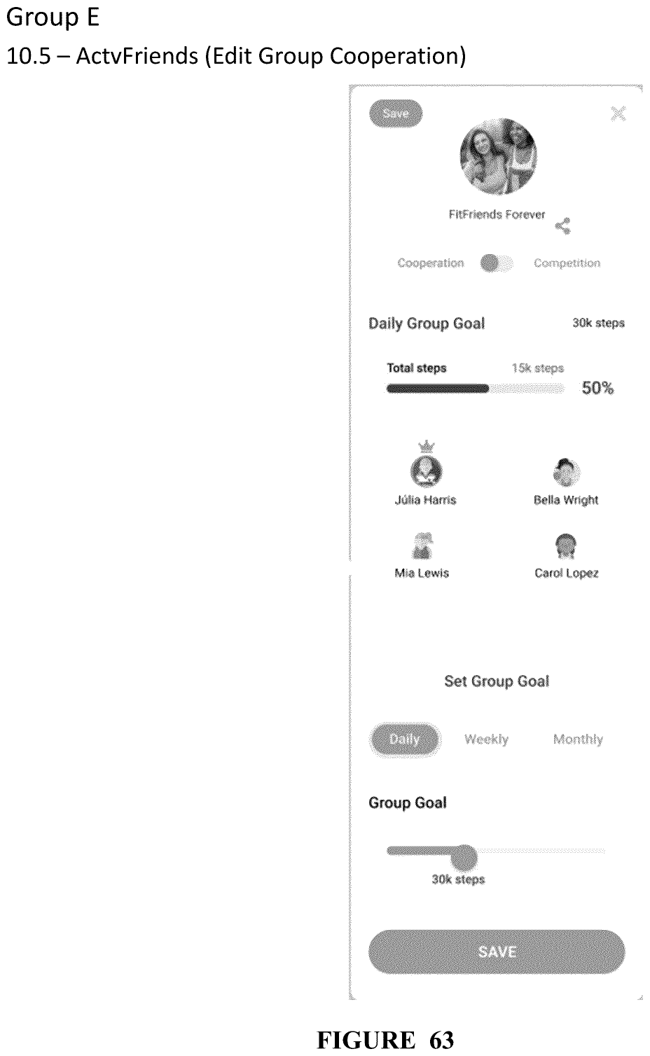

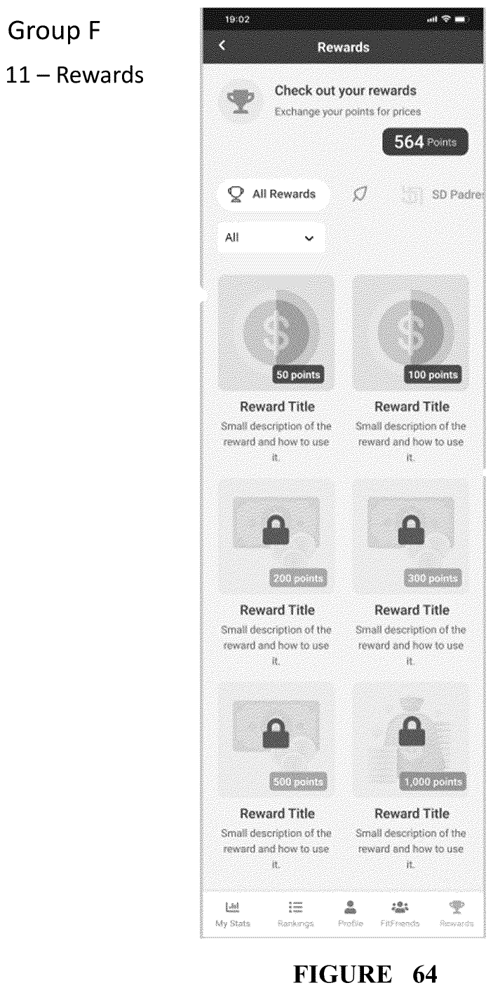

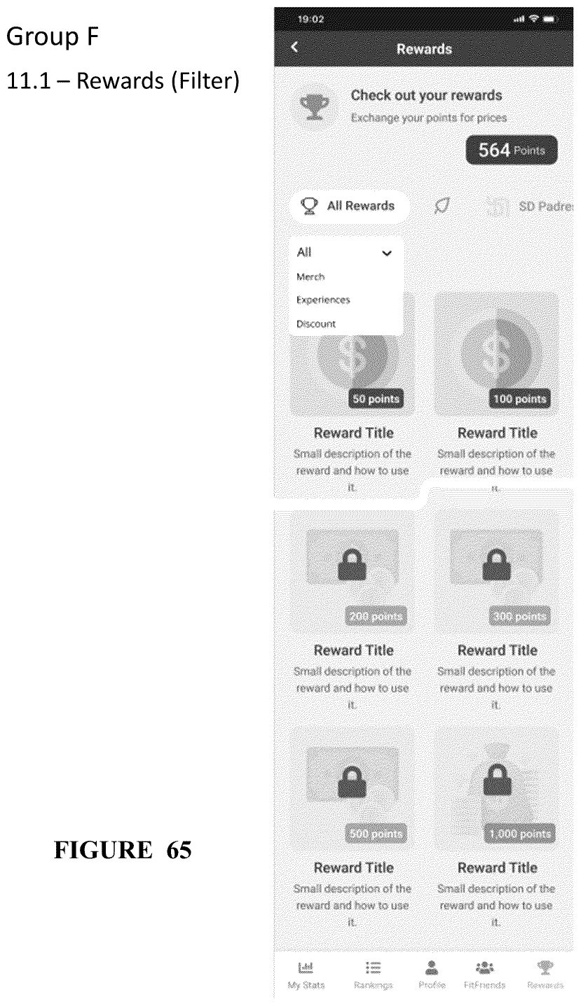

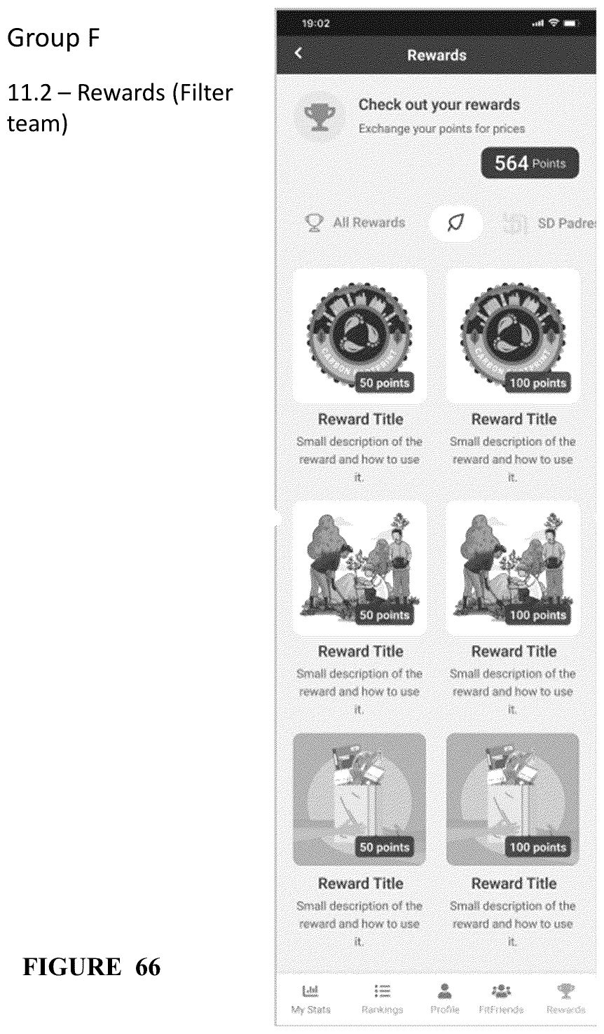

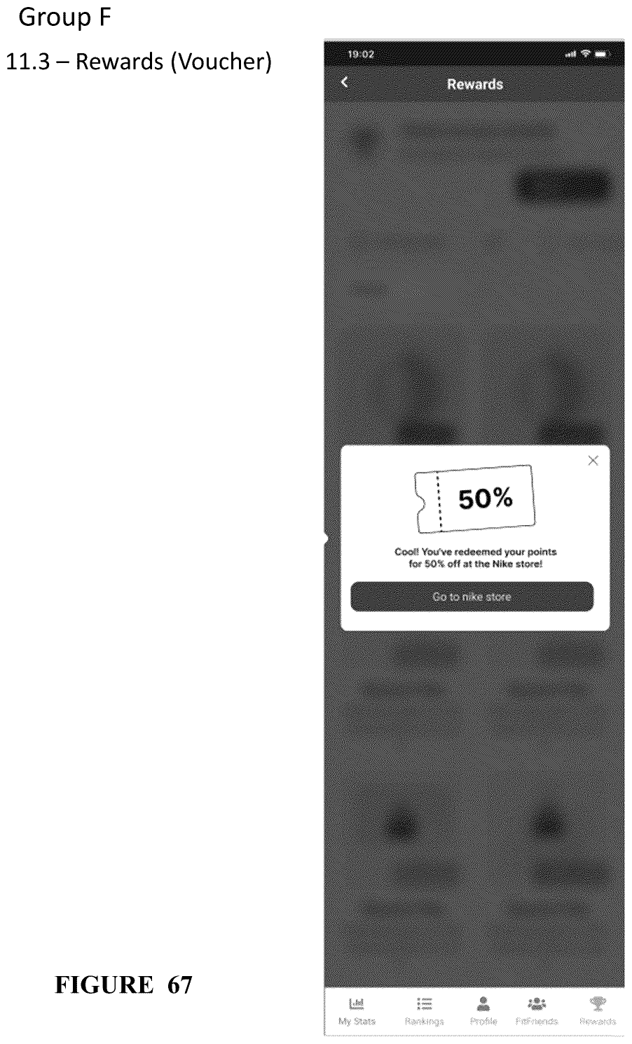

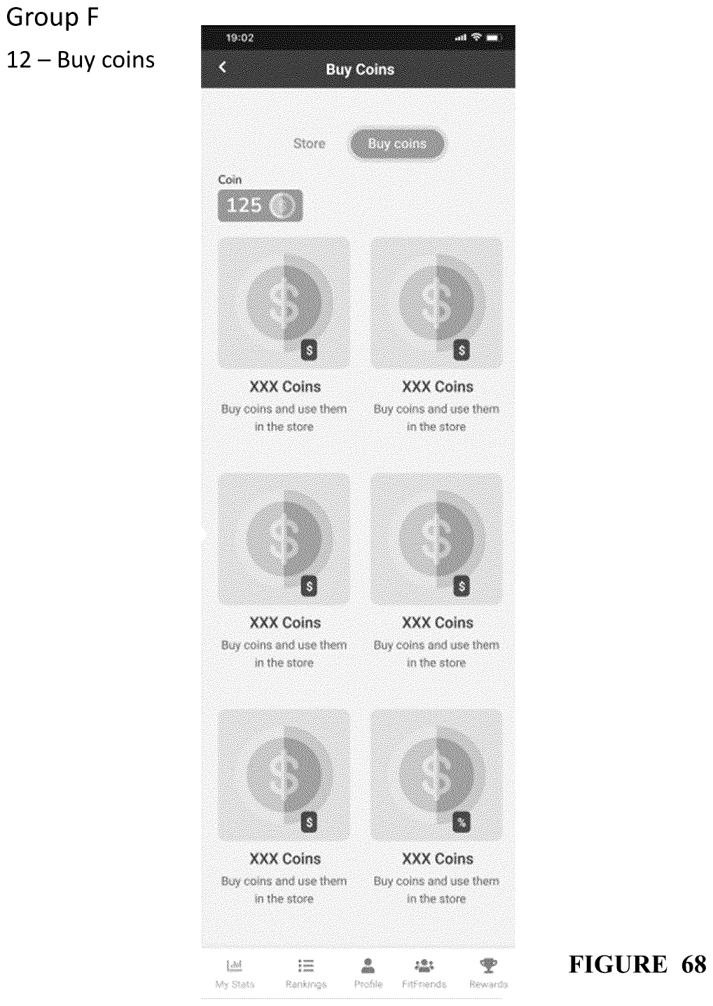

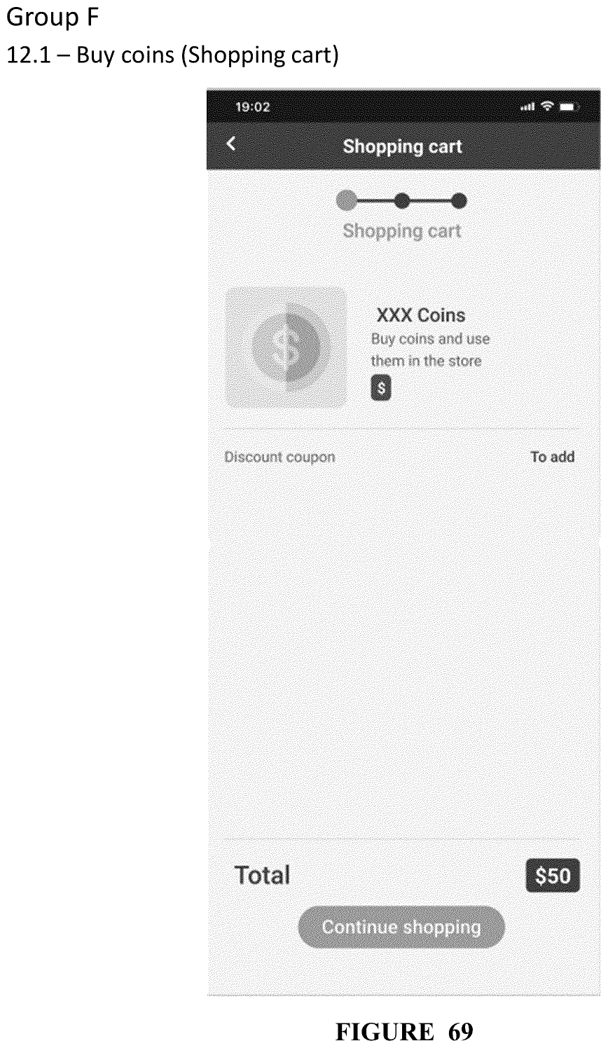

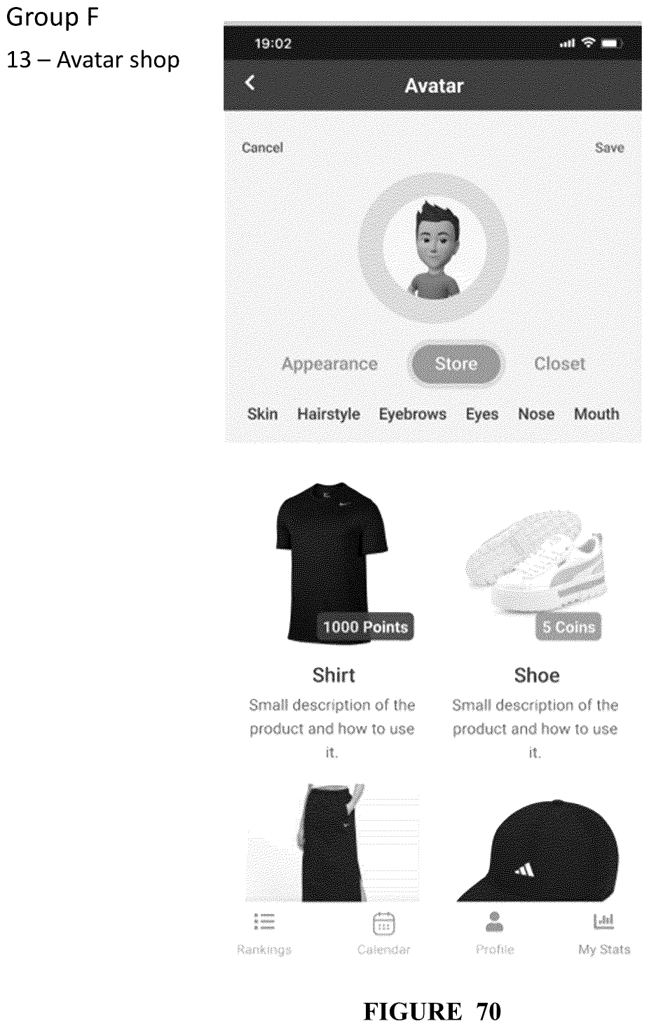

In one aspect, the system is deployed as an app (referred to herein as “ActvFan” or the “ActvFan app”) that is configured to executed on a user device such as a mobile device or a personal computer or the like. FIG. 3-9 illustrate example flow diagrams of example user interface screens that form an example user experience with the ActvFan app. FIGS. 10-70 illustrate detailed views of example user interface screens within the ActvFan app, according to an embodiment. The ActvFan app provides fan engagement and retention. The ActvFan app facilitates ongoing, year-round, fan engagement by providing interaction in non-intrusive ways. Sport organizations, such as professional sport franchises, are chronically challenged with engaging with fans on a year-round basis, in the off-season, during non-game days, and experience particular difficulty connecting and engaging with the Gen Z and younger populations. Through physical activity, ActvFan app users remain active members and represent their respective sport teams, while cooperating, competing, and earning rewards.

The ActvFan app promotes physical activity and community health. Nearly 80% of the U.S. population is physically inactive or doesn't meet the minimum, recommended levels of daily activity. By promoting physical activity in large, pre-established and emotionally-connected communities such as sport fans and school groups, ActvFan successfully influences and promotes massive communities to exercise by appealing to their team allegiance to promote healthy habits.

The ActvFan app is the first solution to blend both organization members/sports fans/spectators and physical activity participants and the first solution that specifically allows sport fans to compete on behalf of their teams through physical activity. With ActvFan, fans become directly connected to their sport teams through physical activity, rather than connection as merely a spectator/supporter.

Historically, fan engagement apps offer traditional features such as scores, quizzes, ecommerce, news, etc. Other apps may spur periodic or sporadic engagement such as live streaming on game days or through seasonal fantasy leagues. The ActvFan app engages users hourly, daily, weekly, and monthly on a year-round basis, encouraging fans to not only be healthier by engaging with their favorite teams via exercise, but also by being rewarded for it. Fans become active participants on behalf of their clubs, competing for their clubs, like a “major league of fans,” i.e., MLB ActvFan League.

The ActvFan app is the first solution to permit fans to compete for their teams and have control over elements such as physical activity and reward gathering. The ActvFan app is also the first solution to foster two-way fan engagement methodologies rather than the conventional and primarily one-sided fan engagement apps that merely allow fans to check today's game times, review historic scores; respond to a quiz, watch a highlights reel of an event that has occurred in the past, etc. in contrast, using the ActvFan app, when a fan is performing a physical activity such as walking or participating in an activity or challenge and the fan is earning rewards through this exercise on behalf of her favorite team, the fan is more likely to remain engaged with that sports team into the future. Fan retention is very important to Sport franchises/organizations and the ActvFan app helps understand fan behaviors that lead to a greater understanding of fan retention.

Regarding promoting physical activity, the ActvFan app harnesses the power of fan communities to get more people to move more. Fandom motivators are embedded into the ActvFan app, and through gamification, the ActvFan app assists organizations and sport franchises to engage deeper with and retain their fans and also help their fan communities be healthier.

In one aspect, the ActvFan app permits organizations and sports teams, as well as \affiliated sponsors, to reward fans for exercising and moving. The premise is that a fan exercises on a regular/daily basis. Each time a fan exercises (e.g., walking), he/she earns points that can be used toward fan-focused rewards. The more frequent the exercise, the more options for fan-focused rewards and thereby greater connection between the fan and the team as well as the more likely a fan is to develop healthy habits and intrinsic motivations to exercise. In this way, the ActvFan app improves fan engagement and retention and increases physical activity and promotes community health.

In one aspect, the ActvFan app is deployed as a business to business to consumer (“B2B2C”) solution. Clients include leagues, organizations, individual sport teams, universities and schools, and the end users include members, sport fans, students, and their parents.

In one aspect, the ActvFan app is configured to integrate with an existing companion application (e.g., mobile app) of a league, organization, individual sports team, university, school, etc. Alternatively, the ActvFan app can be used exclusively as a standalone solution. In one aspect, integration is accomplished by providing access to programmed library functions that are used to provide the primary ActvFan functions to the companion app of the organization. The ActvFan app may also provide application programming interfaces (“APIs”) for the organization to use to access ActvFan functions and integrate the ActvFan app with the companion app.

In one aspect, fans receive a download link or prompt from the organization to register an account within the ActvFan app. Alternatively, a user (fan or student) can download the standalone ActvFan app directly from either Google Play or the Apple store, register as a user and select the organization(s) and/or team(s) they support.

In one aspect, registration captures basic user information such as name, address, height, and weight, as well as names of teams a user supports (fans can select one team from each of many sport leagues, i.e., baseball, soccer), and also information about current exercise habits, exercise goals, favorite sports, and what a User's level of athletic ability is (recreational, professional, etc.). Supplied with this information, the ActvFan app places a user within the appropriate age group and activity level, and the proprietary algorithm adjusts accordingly to create points in exchange for physical activity. For example, a person from a certain age group and weight group receives X number of points per number of steps per day. Points count toward rankings as the user competes against other fans of the same team. In addition, fans supporting the same team will have their points collectively added to compete against fans of other teams, similar to a “League of Fans”. Since organizations, sports teams, and/or schools may have differing fan base sizes, the ActvFan app adjusts for proportionality to ensure fair competition. For example, MLB baseball fans supporting the Padres are a significantly larger fan community than the MLB baseball fans supporting the Dodgers. Accordingly, to ensure fair competition between these two groups, the Dodger fans might be spotted points to account for their natural deficiencies.

In one aspect, the ActvFan app provides a rewards center where users can exchange points (credits) for discounts, merchandise, and experiences, for example. Credits may also generate Non-Fungible Tokens (“NFTs”) that can unlock special benefits. Credits/Points may also be awarded to ActvFan users for completing challenges, engaging with fans/teams, and other various activities. Credits/Points can be used in exchange for NFTs.

In one aspect, organizations may design/select unique digital art (images, audio, video, etc.) which can then be uploaded to the ActvFan Club Admin website. See STEP 1 of “How NFTs are Created” below. Once uploaded, ActvFan servers will add the digital art to a Blockchain. See STEP 2, 3, 4, 5 of “How NFTs are Created” below. The Clubs will then be able to distribute/sell NFTs to ActvFan users in exchange for rewards, completing tasks, or other activities. Fans can then use, gift, or sell NFTs.

Fans can also purchase coins to obtain rewards. Paid membership allows a fan to earn credits to unlock premium rewards such as sport experiences and signed merchandise as well as recommended training plans.

In one aspect, users (also referred to herein as fans) receive notifications and nudges from the ActvFan app to maintain and enhance user motivation, compare user statistics, and see rankings. If a user chooses, he/she/they may remain incognito via a nickname, ID number and/or Avatar.

In one aspect, to make the ActvFan app experience appealing and to support the problems the app is addressing, the ActvFan app is designed to help users develop intrinsic motivation. It is known that some individuals prefer to compete while others prefer to cooperate. The ActvFan app is designed to allow a user to do both, to reach and encourage as many users to participate in physical activity as possible.

Users can also create customized groups within the app (ActvFriends) to promote friendly competitions among groups, and cooperate and motivate one another along the way, even if the users within the ActvFriends group support different teams in different sport leagues. Examples can include cross-league competitions such as NBA v. MLB; SuperBowl Team v. World Series Team; and Taylor Swift Fans v. KC Chiefs NFL Fans.

In one aspect, an ActvFan App use case may include: User 1 is a member of the ActvFan community that supports the LA Lakers NBA team. User 2 is a member of the ActvFan community that supports the SD Padres MLB team. While User 1 and User 2 more generally compete for their specific teams in the ActvFan app, the ActvFriends feature allows User 1 and User 2 to also support each other and/or compete with each other in a personalized group setting.

In one aspect, users select an avatar, which may be dynamic, meaning, the appearance of the physical condition of the avatar will change/improve over time as the user engages in physical activity. For example, an ActvFan app user will enter personal information comprising traits that will be used to create the avatar. As physical challenges are completed, the appearance of the avatar within the ActvFan app will change. For example, if an analysis of the completed exercise determines that the user is adding muscle mass, then the avatar will be modified to show more muscle definition.

In one aspect, when the ActvFan app is defining an ActvFan profile, variables to determine the fan's physical health profile are collected and stored in a database. Some of these variables may include, weight, height, body type, body mass index (“BMI”), and average daily calorie intake, just to name a few. In one aspect, at least some of these variables (or attributes) are used by the ActvFan app to create the avatar appearance. Attributes of the avatar that are dynamic and may change over time include muscle definition, facial expressions, health of skin pigment, etc. Over time, the ActvFan software system will track ActvFan physical challenges which are met, as well as continuous tracking of a Fan's physical health. An example of this could be a determination of (1) more physical activity (2) reduced caloric intake or (3) increase in challenges met, etc., than when the avatar was originally created. Advantageously, as an ActvFan user's physical health improves, and/or challenges are met, then the ActvFan app will dynamically modify the avatar's appearance without direct input from the user. Some examples of Avatar visual modifications include: (1) more muscle definition, (2) happier facial expressions, and (3) more glowing (healthier) skin tone.

Visual stimuli of an improved health indicator further promotes physical activity consistency. A user receives special badges, personalized “skins”, and accolades each time physical activity is completed and as the user works toward achieving his/her/their personal goal (defined in the user registration phase). Augmented Reality (“AR”) experiences such as Geo Location Scavenger Hunts permits users to collect digital credits. For example, a 5 k race organized by a Sport Organization, where a user collects logos and mascots, such as the Padres Friar, along the way, say, at each kilometer, to earn extra credits.

Clubs will select branded digital art (images, audio, video, etc., of a team's logo or mascot, virtual player image, sponsor's logos, etc.) which can then be uploaded to the ActvFan Club Admin website. It will also allow the Club to tag the art with Longitude/Latitude locations to be viewed within the real world.

In one aspect, ActvFan app users will allow their mobile devices to provide GPS data and camera images to be sent to ActvFan servers.

Once ActvFan servers determine that the user is in an area which has been tagged by the Club, the user is notified. The user is notified to use the smartphone's camera—this allows the Club's digital art to appear in real-life, by overlaying a picture/video/audio against the background. In one aspect, the ActvFan app will also integrate with AR glasses to allow for hands-free AR experiences while engaging in physical activity.

In one aspect, the ActvFan app is the first app to blend two segments, (1) sports spectators and (2) sports participants into one solution, allowing fans to be active participants for their teams, competing against other fans of that team and, together, competing against fans of other teams, specifically via tracked physical activity. Advantageously, the ActvFan app interjects physical activity into existing, highly engaged communities of fans. The ActvFan app uses fandom and the existing emotional connection to a team or school as a driving force to motivate people to be physically active. The ActvFan app also allows teams and sponsors the ability to reward fans for healthy habits.

In one aspect, the ActvFan app leverages elements from findings in various sport consumer behavior studies such as group affiliation, team identification (sense of belonging), and sport fan motives (need for socialization, self-esteem, and achievement) to engage users in physical activity participation and develop intrinsic motivation to exercise, thereby ultimately creating healthy habits.

The ActvFan app simultaneously helps organizations such as sport teams to get fans more engaged with their organization while helping the user to develop a healthy habit. While the reward feature of the ActvFan app provides short-term extrinsic motivation (i.e., fans receive discounts on merchandise), users can develop the habit of being more physically active, and therefore more intrinsically motivated by representing their team while completing longer-term goals on a regular, year-round basis.

### Points System

In one aspect, the ActvFan app includes a points system that educates people on efficient and healthy ways to perform a certain physical activity, like walking at an ideal pace for each person based on age, weight, height, current activity level, etc., to achieve optimum health benefits while rewarding that optimum behavior. By integrating physical activity data collected by devices such has smartphones and wearables, the ActvFan app analyzes the activity data and uses its algorithm to translate the physical activity data into points for the user. For this, the ActvFan app uses data provided by and authorized by the user during the registration process, such as gender, anthropometric data (height, weight, body composition), and data collected by a user device (e.g., smartphone, watch, ring, etc.) such as heart rate, total distance during activity, estimated caloric expenditure, sleep hours, exercise frequency and current level of physical activity (ranging from 0 to 7 days a week, beginning to advanced), etc.

In one aspect, each physical activity, as well as daily routine movement such as a regular walk, will be quantified based on data provided by the device (smartphone and/or wearable), which will be then converted into points by the ActvFan app algorithms (or ActvFan server algorithms), based on intensity, duration and type of exercise. In addition, the ActvFan app (or server) algorithm will be adaptive to maximize health benefits based on equations such as the American College of Sport Medicine (ACMS) walking equation, and other ongoing, more recent studies. Besides the regular points awarded for activities, users will also be able to receive bonus points, calculated by an adaptive algorithm.

For example, a person already considered physically active can receive 1 point per 1,000 steps (walking). If that person maintains a frequency of steps of more than 100 steps per minute during 15 consecutive minutes, the person will receive 0.25 bonus points, during 30 minutes will receive 0.50 bonus points, and so on. If this person keeps this regular activity for 4 months, at least 3 to 4 days a week, the algorithm will also adjust, since most likely the individual will have improved physical capacity. This adaptive points system will facilitate understanding by the user and help with exercise adherence.

### Use Case Example

Below is a points system use case example that can be used in one aspect.

For each 1,000 steps within an optimal cadence for that individual, the individual receives 1 point.

If a user maintains a frequency of steps of more than 100 steps per minute during 15 consecutive minutes, there will be a bonus earned of 0.25 points, totaling 1.25 points for each 1,000 steps completed during those 15 minutes.

If a user maintains a frequency of steps of more than 100 steps per minute during 30 consecutive minutes, there will be a bonus earned of 0.50 points, totaling 1.50 points for each 1,000 steps completed during those 30 minutes.

If a user maintains a frequency of steps of more than 100 steps per minute during 45 consecutive minutes, there will be a bonus earned of 0.75 points, totaling 1.75 points for each 1,000 steps completed during those 45 minutes.

If a user maintains a frequency of steps of more than 100 steps per minute during 60 consecutive minutes, there will be a bonus earned of 1 point, totaling 2 points for each 1,000 steps completed during those 60 minutes.

If a user completes activity at a higher intensity, for example, over 130 steps per minute (“brisk walk” with higher heart rate), the User earns double bonus. For example, jogging v. walking, bonus points earned will be 0.50 v. 0.25.

When sleep tracking is available, users will be able to earn points for sleep hours completed, as tracked by a smart device. For example, 6 hours of completed sleep=0.5 point, 7 hours=0.75 point, and 8 hours=1 point.

In this example, while users still receive points for passive walking, or a leisurely, slower walk, such as daily tasks like going to the supermarket, etc., a user will receive 0.5 points for 1,000 steps. The idea is to educate and motivate people to be more active and at a level that optimizes health benefits.

Advantageously, during competitions, the ActvFan points that are accrued by a user (or a team) will be considered for the rankings of the user individually or the user's selected organization, team, school, university and/or company. Fans will compete against other fans of the same team, such as San Diego Padres ActvFan Rankings, and together all the Padres fans will compete against the fans from other MLB teams. The ActvFan app allows for competition and cooperation among fans. For example, K-12 students can compete against other schools, companies can create competition between departments, and also against other companies.

### Achievements With the ActvFan Points System

In one aspect, the ActvFan app (or sever) implements dynamic reward credits based on historical data of the user. Users will be automatically compensated with points, badges and credits towards rewards that might be provided by their teams, schools and/or sponsors, promoting sustainable engagement and ongoing participation to achieve personalized goals, as well as team goals.

### Challenges

The ActvFan app (or server) uses an adaptive algorithm that takes into consideration historical user data to create personalized challenges, stimulating self-motivation to reach goals, and via nudges and notifications will remind and motivate a User to be active.

### Competition

By tapping into the emotional connection of fans and their clubs, and utilizing physical activity data, in one aspect, the ActvFan app (or server) implements asynchronous challenges, so users (fans) can participate anytime, anywhere, and have their points counted toward their individual ranking within the team they support, as well as their team ranking in the league against other teams.

The ActvFan app (or server) also allows the selection of avatars that not only maintain a user's anonymity (if preferred) but also become “healthier” over time as the real person exercises and the appearance of the avatar changes in accordance with the increased exercise and type of exercise.

For school age and youth level users, the ActvFan app (or server) provides parents the ability to control a youth device, such as a phone or tablet, and unlock it after certain activities, established by a parent or guardian, are performed. For example, the ActvFan app (or server) may have a parent portal to create rules for their children. An example rule is that if the child/youth user completes 5,000 steps, the user earns 1 hour of screen time.

The child's electronic device, such as an iPad, can be managed by the ActvFan app (or server) using capabilities native to the operating system of the device (e.g., iOS Family APIs). Once the rule criteria is met (see example above), the ActvFan app (or server) would unlock the child's device.

In one aspect, the ActvFan app (or server) aggregates data from different devices, so users can operate a variety of wearables at different times while having data collected and visible on the ActvFan app (or a website provided by the ActvFan server). In one aspect, this may be done in the following manner:

The ActvFan app (or server) collects physical activity data for the user from multiple devices. Data may include steps, distance, speed, cadence, pace, duration, calories burned, and sleep activity. Throughout the day, the ActvFan app on each of multiple devices sends to the ActvFan server various activity data corresponding to the specific user. For example, a user can wear a Samsung smartwatch to capture steps during day-to-day activities and then shift to using a Garmin smartwatch to capture data for a specific activity such as running. For example, if multiple devices send in step data at the same time (overlap), then the step data will be averaged across all the devices over that time period. Devices may also be prioritized so if there is an overlap in time data, the device with the highest priority, as determined by the user, is used by the ActvFan server. This ensures that multiple devices will not double count steps.

In one aspect, each user must possess a device such as a smartphone or a smartwatch that can collect steps, distance, and pace, etc., for a particular physical activity. With this information captured, the ActvFan app (or server) algorithm(s) create a point system, rankings, notifications, and rewards tailored to the user. User registration is done either via 1) B2B, with ActvFan in partnership with a Sport Organization/School; or 2) B2C, where a user can download the ActvFan app directly from the marketplace.

### Alternative Implementations of the ActvFan System

The ActvFan System including the server(s) and the app(s) can be implemented for a variety of different purposes. Several of these example implementations are listed below.
Fan, Customer, Employee, and Student Engagement Applications
Physical Activity Gamification and Rewards
Fan participation as an active member of their team
Development of intrinsic motivation to exercise
Club/Team/Company Applications
Sport fan and customer analytics
Sponsorship activation
Loyalty ecommerce
ESG & CSR Initiatives
Health Plan Benefits
Wearables and cell phone loyalty programs
Use of AR to enhance experience with the team and sponsors
Engagement with Gen “Z” population through K-12 app module
School and University Applications
Local community fundraisers
Increase student engagement in physical activity
Allow all students to represent their school against other schools (school spirit)

In one aspect, the ActvFan app allows schools to engage students in physical activity on an ongoing basis, in addition to their regular PE classes. Rewards can be in the form of extra school credits, scholarships, school spirit merchandise, etc. Students can also select their favorite professional sport teams to participate in rankings and earn rewards. In some aspects, while only a few students can be selected to play on a school team, the ActvFan system provides the opportunity to every student to represent their school and compete against other schools. Rankings, for example, can be created by school district, city, state, and national levels.

Also, the ActvFan system can be a tool to organize challenges for fundraising such as walkathons. This can be done both via asynchronous challenges (i.e., during a specific timeframe, people can participate in a challenge and donate to a school), and synchronous challenges (i.e., using the app to track distance during an in-person event).

In one aspect, the ActvFan system rewards participants through the organizations they belong to or the clubs they follow so there is a greater incentive for the user/fan to continue. The ActvFan system also provides a non-intrusive way to allow organizations and clubs to communicate with and learn about their fans through incentive programs.

In one aspect, fans/students compete against other fans/students and become active participants of their teams and/or schools. The ActvFan system allows a fan together with other fans, to compete for their teams. Also, the ActvFan system allows for cooperation (fans of a pro team against fans of other pro teams) and competition (fans of the same pro team/club compete against each other).

In one aspect, users have an opportunity to support more than one organizations/team (for example, a fan of an NBA team can also participate as a fan of an NFL team). Many fans support more than one sport team in different leagues, and ActvFan allows a user to select a team from various leagues. For pro teams, this allows the Sport Organization to obtain better insights on fans, and even cross-promote with other teams and leagues.

### Advantages of the ActvFan System

Organizations and team enjoy certain advantages when implementing the ActvFan system. For example, organizations are better able to reach and engage their client base and fans, students on a daily basis, in a non-intrusive way. Organizations are also able to collect more data to improve their service and product offerings and cross-sell premium subscriptions and extended services and products. Organizations are also able to incentivize upsell opportunities via the ActvFan app reward center and affiliate marketing programs, sponsorship activation, and integration with eCommerce. Organizations are also able to reach secondary fans to allow for cross-promotion opportunities (fans that support teams across different leagues).

In one aspect, the ActvFan system employs Artificial Intelligence (Al) to analyze large amounts of data to determine such things as new trends, market segment crossovers, and corollaries in the areas of fan engagement and retention and physical activity, ActvFan draws connections via data points that tell a robust and complete story with the association of physical activity within a highly engaged fan community.

### System Overview—Infrastructure

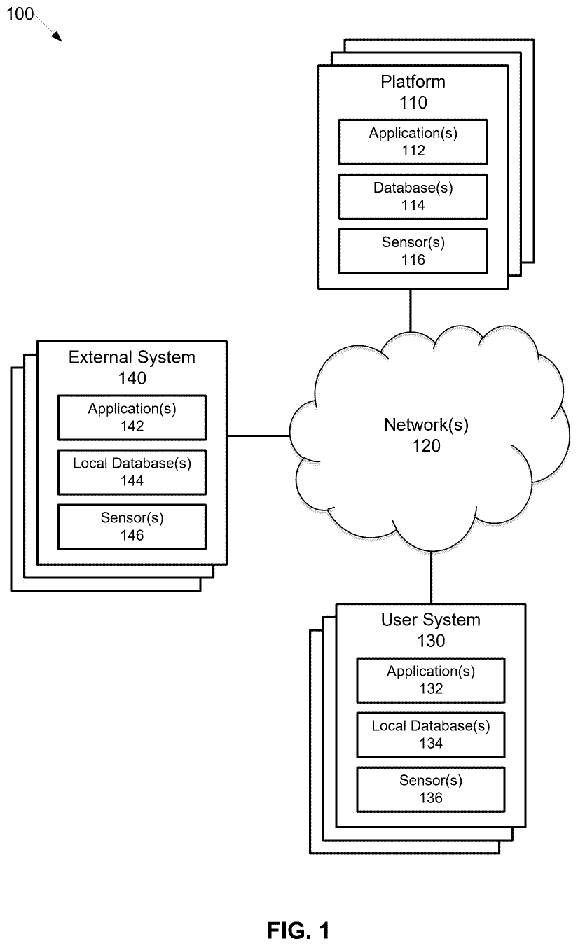

FIG. 1 illustrates an example infrastructure in which one or more of the disclosed processes may be implemented, according to an embodiment. The infrastructure may comprise a platform 110 (e.g., one or more servers) which hosts and/or executes one or more of the various functions, processes, methods, and/or software modules described herein. Platform 110 may comprise dedicated servers, or may instead comprise cloud instances, which utilize shared resources of one or more servers. These servers or cloud instances may be collocated and/or geographically distributed. Platform 110 may also comprise or be communicatively connected to a server application 112 and/or one or more databases 114. For example, the server application 112 may be the ActvFan server application. In addition, platform 110 may be communicatively connected to one or more user systems 130 via one or more networks 120. For example, a user system 130 may be a mobile phone of a user of the ActvFan app. Platform 110 may also be communicatively connected to one or more external systems 140 (e.g., other platforms, websites, etc.) via one or more networks 120. For example, an external system 140 may be a mobile device running a companion app or a server device that runs a companion server application that executes an API to access information from the ActvFan server application 112.

Network(s) 120 may comprise the Internet, and platform 110 may communicate with user system(s) 130 through the Internet using standard transmission protocols, such as HyperText Transfer Protocol (HTTP), HTTP Secure (HTTPS), File Transfer Protocol (FTP), FTP Secure (FTPS), Secure Shell FTP (SFTP), and the like, as well as proprietary protocols. While platform 110 is illustrated as being connected to various systems through a single set of network(s) 120, it should be understood that platform 110 may be connected to the various systems via different sets of one or more networks. For example, platform 110 may be connected to a subset of user systems 130 and/or external systems 140 via the Internet, but may be connected to one or more other user systems 130 and/or external systems 140 via an intranet. Furthermore, while only a few user systems 130 and external systems 140, one server application 112, and one set of database(s) 114 are illustrated, it should be understood that the infrastructure may comprise any number of user systems, external systems, server applications, and databases.

User system(s) 130 may comprise any type or types of computing devices capable of wired and/or wireless communication, including without limitation, desktop computers, laptop computers, tablet computers, smart phones or other mobile phones, servers, game consoles, head mounted displays, augmented reality headsets, virtual reality headsets, televisions, set-top boxes, electronic kiosks, point-of-sale terminals, Automated Teller Machines, and/or the like. User system 130 includes a local database 134 that stores an application 132 that can be executed by a processor of the user system 130. In one aspect, the application 132 is the ActvFan app. User system 130 may also include one or more sensors 136 such as a camera sensor or a step count sensor or a heart rate sensor, or the like.

Platform 110 may comprise web servers which host one or more websites and/or web services. In embodiments in which a website is provided, the website may comprise a graphical user interface, including, for example, one or more screens (e.g., webpages) generated in HyperText Markup Language (HTML) or other language. Platform 110 transmits or serves one or more screens of the graphical user interface in response to requests from user system(s) 130. In some embodiments, these screens may be served in the form of a wizard, in which case two or more screens may be served in a sequential manner, and one or more of the sequential screens may depend on an interaction of the user or user system 130 with one or more preceding screens. The requests to platform 110 and the responses from platform 110, including the screens of the graphical user interface, may both be communicated through network(s) 120, which may include the Internet, using standard communication protocols (e.g., HTTP, HTTPS, etc.). These screens (e.g., webpages) may comprise a combination of content and elements, such as text, images, videos, animations, references (e.g., hyperlinks), frames, inputs (e.g., textboxes, text areas, checkboxes, radio buttons, drop-down menus, buttons, forms, etc.), scripts (e.g., JavaScript), and the like, including elements comprising or derived from data stored in one or more databases (e.g., database(s) 114) that are locally and/or remotely accessible to platform 110. Platform 110 may also respond to other requests from user system(s) 130.

Platform 110 may further comprise, be communicatively coupled with, or otherwise have access to one or more database(s) 114. For example, platform 110 may comprise one or more database servers which manage one or more databases 114. A user system 130 or server application 112 executing on platform 110 may submit data (e.g., user data, form data, etc.) to be stored in database(s) 114, and/or request access to data stored in database(s) 114. Any suitable database may be utilized, including without limitation MySQL™, Oracle™, IBM™, Microsoft SQL™ Access™, PostgreSQL™, and the like, including cloud-based databases and proprietary databases. Data may be sent to platform 110, for instance, using the well-known POST request supported by HTTP, via FTP, and/or the like. This data, as well as other requests, may be handled, for example, by server-side web technology, such as a servlet or other software module (e.g., comprised in server application 112), executed by platform 110.

In embodiments in which a web service is provided, platform 110 may receive requests from external system(s) 140, and provide responses in extensible Markup Language (XML), JavaScript Object Notation (JSON), and/or any other suitable or desired format. In such embodiments, platform 110 may provide an application programming interface (API) which defines the manner in which user system(s) 130 and/or external system(s) 140 may interact with the web service. Thus, user system(s) 130 and/or external system(s) 140 (which may themselves be servers), can define their own user interfaces, and rely on the web service to implement or otherwise provide the backend processes, methods, functionality, storage, and/or the like, described herein. For example, in such an embodiment, a client application 132 executing on one or more user system(s) 130 may interact with a server application 112 executing on platform 110 to execute one or more or a portion of one or more of the various functions, processes, methods, and/or software modules described herein. Client application 132 may be “thin,” in which case processing is primarily carried out server-side by server application 112 on platform 110. A basic example of a thin client application 132 is a browser application, which simply requests, receives, and renders webpages at user system(s) 130, while server application 112 on platform 110 is responsible for generating the webpages and managing database functions. Alternatively, the client application may be “thick,” in which case processing is primarily carried out client-side by user system(s) 130. It should be understood that client application 132 may perform an amount of processing, relative to server application 112 on platform 110, at any point along this spectrum between “thin” and “thick,” depending on the design goals of the particular implementation. In any case, the application described herein, which may wholly reside on either platform 110 (e.g., in which case server application 112 performs all processing) or user system(s) 130 (e.g., in which case client application 132 performs all processing) or be distributed between platform 110 and user system(s) 130 (e.g., in which case server application 112 and client application 132 both perform processing), can comprise one or more executable software modules that implement one or more of the processes, methods, or functions of the application described herein.

### System Overview—Example Processing Device

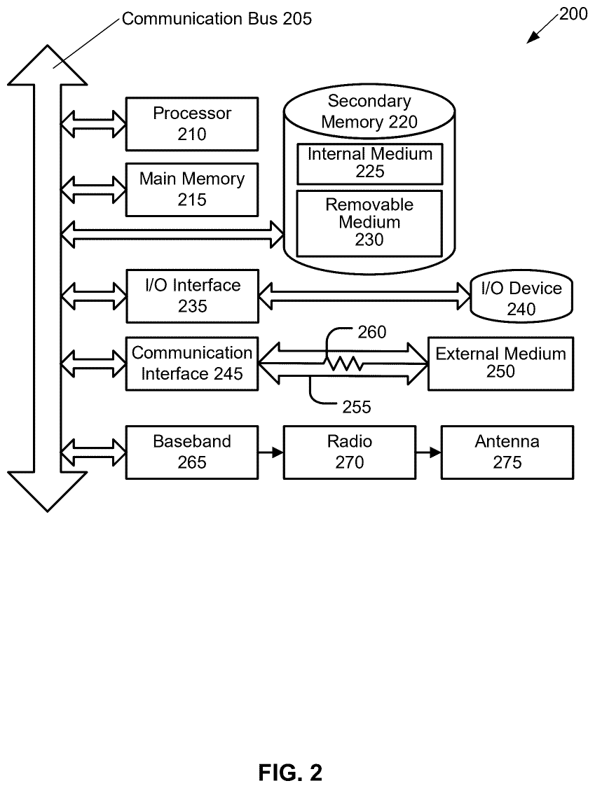

FIG. 2 is a block diagram illustrating an example wired or wireless system 200 that may be used in connection with various embodiments described herein. For example, system 200 may be used as or in conjunction with one or more of the functions, processes, or methods (e.g., to store and/or execute the application or one or more software modules of the application) described herein, and may represent components of platform 110, user system(s) 130, external system(s) 140, and/or other processing devices described herein. System 200 can be a server or any conventional personal computer, or any other processor-enabled device that is capable of wired or wireless data communication. Other computer systems and/or architectures may be also used, as will be clear to those skilled in the art.

System 200 preferably includes one or more processors, such as processor 210. Additional processors may be provided, such as an auxiliary processor to manage input/output, an auxiliary processor to perform floating-point mathematical operations, a special-purpose microprocessor having an architecture suitable for fast execution of signal-processing algorithms (e.g., digital-signal processor), a slave processor subordinate to the main processing system (e.g., back-end processor), an additional microprocessor or controller for dual or multiple processor systems, and/or a coprocessor. Such auxiliary processors may be discrete processors or may be integrated with processor 210. Examples of processors which may be used with system 200 include, without limitation, the Pentium® processor, Core i7® processor, and Xeon® processor, all of which are available from Intel Corporation of Santa Clara, California.

Processor 210 is preferably connected to a communication bus 205. Communication bus 205 may include a data channel for facilitating information transfer between storage and other peripheral components of system 200. Furthermore, communication bus 205 may provide a set of signals used for communication with processor 210, including a data bus, address bus, and/or control bus (not shown). Communication bus 205 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, standards promulgated by the Institute of Electrical and Electronics Engineers (IEEE) including IEEE 488 general-purpose interface bus (GPIB), IEEE 696/S-100, and/or the like.

System 200 preferably includes a main memory 215 and may also include a secondary memory 220. Main memory 215 provides storage of instructions and data for programs executing on processor 210, such as one or more of the functions and/or modules discussed herein. It should be understood that programs stored in the memory and executed by processor 210 may be written and/or compiled according to any suitable language, including without limitation C/C++, Java, JavaScript, Perl, Visual Basic, .NET, and the like. Main memory 215 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

Secondary memory 220 may optionally include an internal medium 225 and/or a removable medium 230. Removable medium 230 is read from and/or written to in any well-known manner. Removable storage medium 230 may be, for example, a magnetic tape drive, a compact disc (CD) drive, a digital versatile disc (DVD) drive, other optical drive, a flash memory drive, and/or the like.

Secondary memory 220 is a non-transitory computer-readable medium having computer-executable code (e.g., disclosed software modules) and/or other data stored thereon. The computer software or data stored on secondary memory 220 is read into main memory 215 for execution by processor 210.

In alternative embodiments, secondary memory 220 may include other similar means for allowing computer programs or other data or instructions to be loaded into system 200. Such means may include, for example, a communication interface 245, which allows software and data to be transferred from external storage medium 250 to system 200. Examples of external storage medium 250 may include an external hard disk drive, an external optical drive, an external magneto-optical drive, and/or the like. Other examples of secondary memory 220 may include semiconductor-based memory, such as programmable read-only memory (PROM), erasable programmable read-only memory (EPROM), electrically erasable read-only memory (EEPROM), and flash memory (block-oriented memory similar to EEPROM).

As mentioned above, system 200 may include a communication interface 245. Communication interface 245 allows software and data to be transferred between system 200 and external devices (e.g. printers), networks, or other information sources. For example, computer software or executable code may be transferred to system 200 from a network server (e.g., platform 110) via communication interface 245. Examples of communication interface 245 include a built-in network adapter, network interface card (NIC), Personal Computer Memory Card International Association (PCMCIA) network card, card bus network adapter, wireless network adapter, Universal Serial Bus (USB) network adapter, modem, a wireless data card, a communications port, an infrared interface, an IEEE 1394 fire-wire, and any other device capable of interfacing system 200 with a network (e.g., network(s) 120) or another computing device. Communication interface 245 preferably implements industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software and data transferred via communication interface 245 are generally in the form of electrical communication signals 260. These signals 260 may be provided to communication interface 245 via a communication channel 255. In an embodiment, communication channel 255 may be a wired or wireless network (e.g., network(s) 120), or any variety of other communication links. Communication channel 255 carries signals 260 and can be implemented using a variety of wired or wireless communication means including wire or cable, fiber optics, conventional phone line, cellular phone link, wireless data communication link, radio frequency (“RF”) link, or infrared link, just to name a few.

Computer-executable code (e.g., computer programs, such as the disclosed application, or software modules) is stored in main memory 215 and/or secondary memory 220. Computer programs can also be received via communication interface 245 and stored in main memory 215 and/or secondary memory 220. Such computer programs, when executed, enable system 200 to perform the various functions of the disclosed embodiments as described elsewhere herein.

In this description, the term “computer-readable medium” is used to refer to any non-transitory computer-readable storage media used to provide computer-executable code and/or other data to or within system 200. Examples of such media include main memory 215, secondary memory 220 (including internal memory 225, removable medium 230, and external storage medium 250), and any peripheral device communicatively coupled with communication interface 245 (including a network information server or other network device). These non-transitory computer-readable media are means for providing executable code, programming instructions, software, and/or other data to system 200.

In an embodiment that is implemented using software, the software may be stored on a computer-readable medium and loaded into system 200 by way of removable medium 230, I/O interface 235, or communication interface 245. In such an embodiment, the software is loaded into system 200 in the form of electrical communication signals 260. The software, when executed by processor 210, preferably causes processor 210 to perform one or more of the processes and functions described elsewhere herein.

In an embodiment, I/O interface 235 provides an interface between one or more components of system 200 and one or more input and/or output devices 240. Example input devices include, without limitation, sensors, keyboards, touch screens or other touch-sensitive devices, biometric sensing devices, computer mice, trackballs, pen-based pointing devices, and/or the like. Examples of output devices include, without limitation, other processing devices, cathode ray tubes (CRTs), plasma displays, light-emitting diode (LED) displays, liquid crystal displays (LCDs), printers, vacuum fluorescent displays (VFDs), surface-conduction electron-emitter displays (SEDs), field emission displays (FEDs), head mounted displays (HMDs), and/or the like. In some cases, an input and output device 240 may be combined, such as in the case of a touch panel display (e.g., in a smartphone, tablet, or other mobile device).

In an embodiment, the I/O device 240 may be any type of external or integrated display and may include one or more discrete displays that in aggregate form the I/O device 240. The I/O device 240 may be capable of 2D or 3D presentation of visual information to a user of the system 200. In one embodiment, the I/O device 240 may be a virtual reality or augmented reality device in the form of HMD by the user so the user may visualize the presentation of information in 3D.

System 200 may also include optional wireless communication components that facilitate wireless communication over a voice network and/or a data network (e.g., in the case of user system 130). The wireless communication components comprise an antenna system 275, a radio system 270, and a baseband system 265. In system 200, radio frequency (RF) signals are transmitted and received over the air by antenna system 275 under the management of radio system 270.

In an embodiment, antenna system 275 may comprise one or more antennae and one or more multiplexors (not shown) that perform a switching function to provide antenna system 275 with transmit and receive signal paths. In the receive path, received RF signals can be coupled from a multiplexor to a low noise amplifier (not shown) that amplifies the received RF signal and sends the amplified signal to radio system 270.

In an alternative embodiment, radio system 270 may comprise one or more radios that are configured to communicate over various frequencies. In an embodiment, radio system 270 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from radio system 270 to baseband system 265.

If the received signal contains audio information, then baseband system 265 decodes the signal and converts it to an analog signal. Then the signal is amplified and sent to a speaker. Baseband system 265 also receives analog audio signals from a microphone. These analog audio signals are converted to digital signals and encoded by baseband system 265. Baseband system 265 also encodes the digital signals for transmission and generates a baseband transmit audio signal that is routed to the modulator portion of radio system 270. The modulator mixes the baseband transmit audio signal with an RF carrier signal, generating an RF transmit signal that is routed to antenna system 275 and may pass through a power amplifier (not shown). The power amplifier amplifies the RF transmit signal and routes it to antenna system 275, where the signal is switched to the antenna port for transmission.

Baseband system 265 is also communicatively coupled with processor 210, which may be a central processing unit (CPU). Processor 210 has access to data storage areas 215 and 220. Processor 210 is preferably configured to execute instructions (i.e., computer programs, such as the disclosed application, or software modules) that can be stored in main memory 215 or secondary memory 220. Computer programs can also be received from baseband processor 260 and stored in main memory 210 or in secondary memory 220, or executed upon receipt. Such computer programs, when executed, enable system 200 to perform the various functions of the disclosed embodiments.

### Appendix

The appendix includes a plurality of example user interface screens and demonstrate one or more example flows between various user interface screens that a user might experience when using the ActvFan app. The appendix also includes examples of individual user interface screens that may appear to a user when using the ActvFan app.

In one aspect, the various example user interface screen flows may be carried out by the system described with respect to FIG. 1 in combination with one or more processing devices described with respect to FIG. 2.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

What is claimed is:

1. A system comprising at least one processor communicatively coupled with at least one non-transitory computer readable medium, wherein the processor is programmed to:
associate a first plurality of users with a first organization;
associate a second plurality of users with a second organization;
track physical activity of one or more of the first plurality of users;
aggregate the tracked physical activity of the one or more of the first plurality of users to determine a first organization amount of physical activity;
track physical activity of one or more of the second plurality of users;
aggregate the tracked physical activity of the one or more of the second plurality of users to determine a second organization amount of physical activity;
compare the first organization amount of physical activity to the second organization amount of physical activity to determine a winner in a competition between the first plurality of users associated with the first organization and the second plurality of users associated with the second organization.

2. A computer implemented method where one or more processors are programmed to perform steps comprising:
associate a first plurality of users with a first organization;
associate a second plurality of users with a second organization;
track physical activity of one or more of the first plurality of users;
aggregate the tracked physical activity of the one or more of the first plurality of users to determine a first organization amount of physical activity;
track physical activity of one or more of the second plurality of users;
aggregate the tracked physical activity of the one or more of the second plurality of users to determine a second organization amount of physical activity;
compare the first organization amount of physical activity to the second organization amount of physical activity to determine a winner in a competition between the first plurality of users associated with the first organization and the second plurality of users associated with the second organization.

3. A non-transitory computer readable medium having stored thereon one or more sequences of instructions for causing one or more processors to perform steps comprising:
associate a first plurality of users with a first organization;
associate a second plurality of users with a second organization;
track physical activity of one or more of the first plurality of users;
aggregate the tracked physical activity of the one or more of the first plurality of users to determine a first organization amount of physical activity;
track physical activity of one or more of the second plurality of users;
aggregate the tracked physical activity of the one or more of the second plurality of users to determine a second organization amount of physical activity;
compare the first organization amount of physical activity to the second organization amount of physical activity to determine a winner in a competition between the first plurality of users associated with the first organization and the second plurality of users associated with the second organization.
